(19) United States
(12) Patent Application Publication
(10) Pub. No.: US 2020/0342446 A1
(43) Pub. Date: Oct. 29, 2020

(54) SUPER SMART SECURE PAYMENT APPLETS WITH PRE-STORED MESSAGES AND LOGIC AND ABILITY TO CHANGE SUBSEQUENT FUNCTION THEREON

(71) Applicant: Dynamics Inc., Cheswick, PA (US)

(72) Inventors: Jeffrey D. Mullen, Glenshaw, PA (US); Ryan Patrick Dew, Pittsburgh, PA (US); Andrew Veter, Pittsburgh, PA (US); Keith Huthmacher, Pittsburgh, PA (US)

(21) Appl. No.: 16/849,902

(22) Filed: Apr. 15, 2020

Related U.S. Application Data
(60) Provisional application No. 62/837,552, filed on Apr. 23, 2019.
(60) Provisional application No. 62/845,755, filed on May 9, 2019.
(60) Provisional application No. 62/851,054, filed on May 21, 2019.
(60) Provisional application No. 62/863,149, filed on Jun. 18, 2019.
(60) Provisional application No. 62/897,319, filed on Sep. 7, 2019.

(51) Int. Cl. G06Q 20/34; G06Q 20/38; H04W 4/029; H04W 4/35

(52) U.S. Cl. CPC G06Q 20/357; H04W 4/35; H04W 4/029; G06Q 20/381

(57) ABSTRACT

A system may include a payment card operable to receive information operable to modify an applet or cause modification of information by an applet.

### CROSS-REFERENCE TO RELATED APPLICATION

This application claims the benefit of U.S. Provisional Patent Application No. 62/837,552, titled “CARDS, DEVICES, SYSTEMS, APPLICATIONS AND MULTISTAGE COUPONS,” filed Apr. 23, 2019 (as Attorney Docket No. D/172PROV), U.S. Provisional Patent Application No. 62/845,755, titled “CARDS, DEVICES, SYSTEMS, APPLICATIONS AND MULTISTAGE COUPONS,” filed May 9, 2019 (as Attorney Docket No. D/173PROV), U.S. Provisional Patent Application No. 62/851,054, titled “CARDS, DEVICES, SYSTEMS, APPLICATIONS AND BARCODE PAYMENTS,” filed May 21, 2019 (as Attorney Docket No. D/174PROV), U.S. Provisional Patent Application No. 62/863,149, titled “SUPER SMART SECURE PAYMENT APPLETS WITH PRE-STORED MESSAGES AND LOGIC AND ABILITY TO CHANGE SUBSEQUENT FUNCTION THEREON,” filed Jun. 18, 2019 (as Attorney Docket No. D/175PROV), U.S. Provisional Patent Application No. 62/897,319, titled “SUPER SMART SECURE PAYMENT APPLETS WITH PRE-STORED MESSAGES AND LOGIC AND ABILITY TO CHANGE SUBSEQUENT FUNCTION THEREON,” filed Sep. 7, 2019 (as Attorney Docket No. D/176PROV), each of which is hereby incorporated by reference herein in its entirety.

### BACKGROUND OF THE INVENTION

This invention relates to magnetic cards, devices and payment systems.

### SUMMARY OF THE INVENTION

Systems and methods are provided for allowing a user to select an additional service to be performed in addition to the payment of goods with a payment card and/or other device (e.g., a mobile telephonic device, a tablet computer device, and/or other electronic device). A “card” may be used to denote powered cards, non-powered cards and other devices (e.g., powered or non-powered electronic devices, for example, computing devices).

A card may include one or more buttons. A user may associate an additional service to a button of a card at any time. At the time of purchase, information indicative of the button the user selected may be passed to a point-of-sale system with a user's payment information. Such data may be, for example, communicated through a merchant acquirer's network to a processing facility.

The processing facility may, for example, authorize a payment transaction and forward the information indicative of the button a user selected and the identity of a user to a remote facility. Such a remote facility may, for example, forward at least some of such information, as well as additional information, to a third party service provider such that the third party service provider enacts the additional feature desired by the user.

Such an additional feature may include, for example, earning and/or using a coupon provided by a coupon provider, the addition of value to a coupon by a retailer acting as an application provider, earning of a random reward from a manufacturer, and/or the like.

Selection of a feature may be provided, for example, by a Graphical User Interface (GUI) provided on a computing device (e.g., a mobile telephonic device) as a software and/or hardware application for that device, and/or via the internet or an intranet through a web browser. Such a selection may be provided with a non-powered card such that a single feature may be associated with a non-powered card for a period of time. Such a selection may be associated to an option (e.g., a button) on a powered card or other device (e.g., a mobile telephonic device) such that the user may associate different features with different options (e.g., different buttons).

Accordingly, for example, a user may receive a card (e.g., a powered card, non-powered card and/or other device) in the mail and use his/her web browser to associate different additional features to different buttons. The user may then utilize the card in a store and press a button in order to select that feature. A card may download information (e.g., via a wireless communication such as a light and/or electromagnetic communication) such that the card, and/or other device, displays information next to an option indicative of the feature (e.g., “Redeem LivingSocial Voucher,” “Facebook Like”). Alternatively, no download may be provided and no additional information may be displayed such that a user's card, and/or other device, includes a generic descriptor (e.g., “credit” and “feature,” or “feature 1” and “feature 2,” or “debit” and “feature 1” and “feature 2”).

A remote facility may also receive additional information than just a user identifier and information indicative of the option selected by a user (or that the user made a payment). Such additional information may be, for example, the type of merchant (e.g., a retail merchant or a gas merchant), the location of a merchant (e.g., the zip code of a merchant), the type of transaction (e.g., online or in-store purchase), the name of the merchant (e.g., “Amazon.com,” or “Walmart”), the amount of the transaction (e.g., $10.25), and any other information. Such a remote facility may forward such information to a third party service provider in addition to information generated by the remote facility (e.g., a second user identifier such that different identifiers are used with the facility sending payment information and the third party service provider).

A feature/payment method ecosystem may be provided in which a development kit is available for third parties to develop applications for payment cards or other devices. A GUI may be provided where a user can select different third party applications to be associated with one or more user payment methods. The third party applications may be approved by an administrator and/or an approval signature flow before being accessible by a GUI. Different categories of third party applications may be provided on the GUI (e.g., a coupon category, a check-in category, a games category, a financial management tools category). The development kit may provide the ability for a third party service provider to, for example, receive user identification numbers and other information, (e.g., merchant name and location) and provide particular information (e.g., within a period of time) to a remote facility.

Information received from a third party service provider may include, for example, information indicative that the user was properly identified and a service was performed (e.g., “check-in completed,” “information added to financial management service.”). Such information may be provided back to an issuing bank, processor, or other service provider such that the information may be displayed on a user's billing statement. Additional information may also be provided that may change the way a transaction is authorized or settled.

Additional information received from a third party may be utilized to change the way a transaction is authorized or settled. For example, a third party may provide a user with the ability to pre-purchase a voucher to a particular store (e.g., a particular barber in a particular zip code). A user may associate this third party service to a button on the user's card. For example, a user may purchase a service at a barber multiple times during a year on the user's credit account. The user may, at one such purchase, press the button associated with the desire to use the third party service and redeem a voucher the user already purchased or acquired. Information indicative of the user's desire to utilize such a service may be communicated to a point-of-sale terminal via a communications device located on the card (e.g., a dynamic magnetic stripe communications device, an RFID antenna, an exposed IC chip (e.g., an EMV chip, or any other communications device). The transaction may be authorized using the user's payment account if, for example, the user has enough funds associated with that account (e.g., a credit or debit account).

The third party service provider may then determine the user had a pre-paid voucher for the transaction and may return to the card issuer, processor, and/or other party information indicative that the user's bill is to be adjusted by the amount of the voucher. Before, or after, settlement occurs a user's bill may show a statement credit in the amount of the voucher. A remote facility may perform such a data exchange as well as any associated value exchange. For example, the remote facility may, for a fee (e.g., a percentage of a transaction or a fixed fee), provide value from the third party service provider to the card issuer or processor (e.g., via an ACH or other type of monetary transaction).

Alternatively, for example, the remote facility may provide the desired value to the card issuer, processor, and/or other party and demand the associated value be paid to the remote facility by the third party service provider within a period of time (e.g., three days). Information provided by a third party service provider to a remote facility may include an identifier indicative of the third party service provider, an identifier indicative of the user, an identifier indicative of the type of service provided by the third party service provider, an identifier indicative of the transaction with which further action by the third party service provider is desired, an amount of a post-statement credit that is to be applied for a particular transaction, and amount of a post-settlement credit that is to be applied for a particular transaction, an amount of a pre-settlement credit that is to be applied for a particular transaction, an amount of a credit that is to be applied during an authorization, an additional fee to be added to a statement for an additional service (e.g., a fee-based financial management tool service), and any other information desired by the third party service provider, processor, card issuer, remote facility, device provider, and/or any other entity (e.g., a card network).

Information indicative of a button press, and/or use of a card, that triggers a feature may be provided in a payment message utilized at authorization or at settlement. Furthermore, the service provider may return information in a period of time that permits actions to be performed pre-authorization and/or pre-settlement.

The payment actions may be determined, for example, via a user interaction with the card. Particularly, for example, a user may press a button on the card, from a group of buttons, the button being associated with the third party feature. The third party feature may be unique from the features provided to the user via the third party's non-payment card or device services. Accordingly, a user may obtain the benefit of the whimsical and festive nature of a unique feature every time the user makes a payment.

Information indicative of feature selection may be provided, for example, via an output device operable to be read by a card reader. For example, the feature selection may be communicated by a dynamic magnetic stripe communications device, an RFID antenna, an exposed IC chip, or any other type of output device. For online purchases, for example, a display may be provided on the card and a user selection may cause a particular number (e.g., a particular code) to be displayed on the card. Such a code may be entered into a text box on a website at checkout and may be representative of the user's desired feature. Accordingly, the feature may be communicated to a remote server such that the feature may be performed in the third party service on behalf of the user. The code may additionally provide the benefits of a security code and may be entered with a payment card number (e.g., a credit or debit card number) at online or in-store checkout. If a code is not representative of a feature, for example, a default feature may be provided.

Rewards may be awarded based on the amount of a purchase. Such rewards may be associated with a third party service or a card issuer, card provider, or other entity. For example, a coupon may be awarded by an application provider at every purchase instead of a card issuer providing an amount of points, miles, or cashback to a user. Alternatively, for example, a user may earn both rewards from a card issuer as well as rewards from a third party service provider. A user may select, via, for example, physical buttons on the card or virtual buttons on a capacitive-sensitive display of a mobile telephonic device, the type of feature the user desires. Multiple features may be provided from a particular third party service provider. For example, a coupon provider may provide a feature associated with a coupon and another feature associated with another coupon.

A card may include a dynamic magnetic communications device. Such a dynamic magnetic communications device may take the form of a magnetic encoder and/or a magnetic emulator. A magnetic encoder may change the information located on a magnetic medium such that a magnetic stripe reader may read changed magnetic information from the magnetic medium. A magnetic emulator may generate electromagnetic fields that directly communicate data to a magnetic stripe reader. Such a magnetic emulator may communicate data serially to a read-head of the magnetic stripe reader.

All, or substantially all, of the front as well as the back of a card may be a display (e.g., bi-stable, non bi-stable, LCD, LED, or electrochromic display). Electrodes of a display may be coupled to one or more capacitive touch sensors such that a display may be provided as a touch-screen display. Any type of touch-screen display may be utilized. Such touch-screen displays may be operable of determining multiple points of touch. A barcode may be displayed across all, or substantially all, of a surface of a card. In doing so, computer vision equipment such as barcode readers may be less susceptible to errors in reading a displayed barcode.

A card may include a number of output devices to output dynamic information. For example, a card may include one or more RFIDs and/or IC chips to communicate to one or more RFID readers or IC chip readers, respectively. According to some example embodiments, a card may include three or more different types of output devices. A card may include devices to receive information. For example, an RFID and IC chip may both receive information and communicate information to an RFID and IC chip reader, respectively.

A device for receiving wireless information signals may be provided. A light sensing device and/or sound sensing device may be utilized to receive information wirelessly. A card may include a central processor that communicates data through one or more output devices simultaneously (e.g., an RFID, IC chip, and a dynamic magnetic stripe communications device). The central processor may receive information from one or more input devices simultaneously (e.g., an RFID, IC chip, dynamic magnetic stripe devices, light sensing device, and a sound sensing device). A processor may be coupled to surface contacts such that the processor may perform the processing capabilities of, for example, an EMV chip. The processor may be laminated over and not exposed such that such a processor is not exposed on the surface of the card.

A card may be provided with a button in which the activation of the button causes a code to be communicated through a dynamic magnetic stripe communications device (e.g., the subsequent time a read-head detector on the card detects a read-head). The code may be indicative of, for example, a feature (e.g., a payment feature). The code may be received by the card via manual input (e.g., onto buttons of the card) or via a wireless transmission (e.g., via light, electromagnetic communications, sound, or other wireless signals). A code may be communicated from a webpage (e.g., via light and/or sound) to a card. A card may include a display such that a received code may be visually displayed to a user. In doing so, the user may be provided with a way to select, and use, the code via both an in-store setting (e.g., via a magnetic stripe reader) or an online setting (e.g., by reading the code from a display and entering the code into a text box on a checkout page of an online purchase transaction).

A remote server, such as a payment authorization server, may receive the code and may process a payment differently based on the code received. For example, a code may be a security code to authorize a purchase transaction. A code may provide a payment feature such that a purchase may be made with points, debit, credit, installment payments, and/or deferred payments via a single payment account number (e.g., a credit card number) to identify a user and a payment feature code to select the type of payment a user desires to utilize.

A dynamic magnetic stripe communications device may include a magnetic emulator that comprises an inductor (e.g., a coil). Current may be provided through this coil to create an electromagnetic field operable to communicate with the read-head of a magnetic stripe reader. The drive circuit may vary the amount of current travelling through the coil such that a track of magnetic stripe data may be communicated to a read-head of a magnetic stripe reader. A switch (e.g., a transistor) may be provided to enable or disable the flow of current according to, for example, a frequency/double-frequency (F2F) encoding algorithm. In doing so, bits of data may be communicated.

Electronics may be embedded between two layers of a polymer (e.g., a PVC or non-PVC polymer). One or more liquid polymers may be provided between these two layers. The liquid polymer(s) may, for example, be hardened via a reaction between the polymers (or other material), temperature, and/or via light (e.g., an ultraviolet or blue spectrum light) such that the electronics become embedded between the two layers of the polymer and a card is formed.

A payment card or other device may receive information indicative of a feature desired to be added by a user. The payment card may communicate information indicative of the feature with payment card data associated with the card or a user selection. The payment data and feature information may be routed, for example, to an authorization server. The authorization server may authorize payment and, based on the authorized payment, communicate the feature information to a remote server. The remote server may utilize this remote information to impact a third party service. The feature information may, for example, be routed before the payment card data reaches an authorization server.

At merchant settlement, charge backs for a purchase associated with a reward (e.g., a coupon) may cause the feature to be reversed or a different feature to be implemented (e.g., a removal of rewards earned at authorization). According to some example embodiments, the feature may be implemented at settlement upon confirmation that, for example, no chargeback was associated with the payment transaction.

A graphical user interface (GUI) may be provided to allow users to display one or more application managers and one or more application provider interfaces. The GUI may be rendered onto a display of a card (e.g., a powered card, a mobile telephonic device, an electronic tablet, a laptop computer, or a desktop computer) and may allow a user to configure features that are desired to be added by the user.

A user may, for example, associate a card with one or more third party service features using the application manager. Such an application manager may be an interface to an ecosystem of applications and payment methods, where users within the ecosystem may manage which application(s) may be associated with a particular payment method (e.g., payment method card). A user may alter such associations at any time. Prior to associating one or more applications to a particular payment method, the payment method may be associated with one or more default applications that may be later modified by the user.

A GUI may be provided on an electronic device to administer one or more third party applications that facilitate the provision of coupons and/or the addition of value to coupons. The coupons and/or additional value may be earned by a user upon completion of a performance metric. A coupon may be selected by a user from every coupon made available by an application and/or feature provider, the coupon may be automatically determined and/or a coupon may selected by a user from a number of hidden coupons (e.g., via a virtual scratch-off). For example, an application provider may be a coupon provider that distributes coupons from a variety of retailers, a retailer and/or a collection of retailers. A user of a payment method, for example a powered card, may earn a coupon and/or add value to a coupon each time the user spends a target amount of money using the powered card. Additionally and/or alternatively, a user may receive a reward randomly from a collection of rewards including coupons, virtual items and tangible items, and/or select a blank reward from among multiple blank rewards to reveal a coupon.

A performance metric may include, for example, a purchase with a card (e.g., a physical and/or virtual payment method card), a sequence of purchases (e.g., ten purchases), a total amount spent, and/or other metrics related to various purchasing and/or non-purchasing transactional events.

A reward may scale based on an associated performance metric. The greater the burden placed on a user by a performance metric, the greater the reward may be. For example, a coupon may be earned from all coupons provided by a coupon provider each time a user makes purchases meeting or exceeding a specific dollar amount. For a dollar amount exceeding the specific dollar amount, a user may instead receive multiple coupons and/or add additional value to a coupon.

According to some example embodiments, a computing device may receive a first message including a coupon identifier of a multistage coupon, obtain a monetary value of a current stage of the multistage coupon based on the coupon identifier, and communicate a second message based on the first message, the second message indicating the monetary value of the current stage of the multistage coupon. The multistage coupon may not be associated with a user. Whether a condition to awarding the monetary value is met may be determined. The first message may include at least a portion of purchase transaction data, and the determination that the condition is met may be based on the at least a portion of the purchase transaction data. The current stage and a stage threshold may be obtained, and a determination made as to whether the current stage is equal to or exceeds the threshold. The second message may include an indication of card eligibility upon determining that the current stage is equal to or exceeds the threshold. According to some example embodiments, a point of sale (POS) terminal may receive a barcode including a payment routing identity and communicate the barcode and data associated with a purchase transaction based on the routing identity. The POS terminal may receive a second barcode associated with at least one of an installment, a loyalty account, a discount and a request to pay for all or a portion of a purchase with points.

### BRIEF DESCRIPTION OF THE DRAWINGS

The principles and advantages of the present invention can be more clearly understood from the following detailed description considered in conjunction with the following drawings, in which the same reference numerals denote the same structural elements throughout, and in which:

FIG. 1 is an illustration of a card and architecture constructed in accordance with the principles of the present invention;

FIG. 2 is an illustration of a device constructed in accordance with the principles of the present invention;

FIG. 3 is an illustration of a network topology constructed in accordance with the principles of the present invention;

FIG. 4 is an illustration of a device constructed in accordance with the principles of the present invention;

FIG. 5 is an illustration of a device constructed in accordance with the principles of the present invention;

FIG. 6 is an illustration of a process flow chart constructed in accordance with the principles of the present invention;

FIG. 7 is an illustration of a device constructed in accordance with the principles of the present invention;

FIG. 8 is an illustration of a device constructed in accordance with the principles of the present invention;

FIG. 9 is an illustration of a process flow chart constructed in accordance with the principles of the present invention;

FIG. 10 is an illustration of a process flow chart constructed in accordance with the principles of the present invention;

FIG. 11 is an illustration of a process flow charts constructed in accordance with the principles of the present invention;

FIG. 12 is an illustration of a process flow chart constructed in accordance with the principles of the present invention;

FIG. 13 is an illustration of a process flow chart constructed in accordance with the principles of the present invention;

FIG. 14 is an illustration of a process flow chart constructed in accordance with the principles of the present invention; and

FIG. 15 is an illustration of a thin mechanical slider usable on a card and/or card chip in accordance with the principles of the present invention.

### DETAILED DESCRIPTION OF THE INVENTION

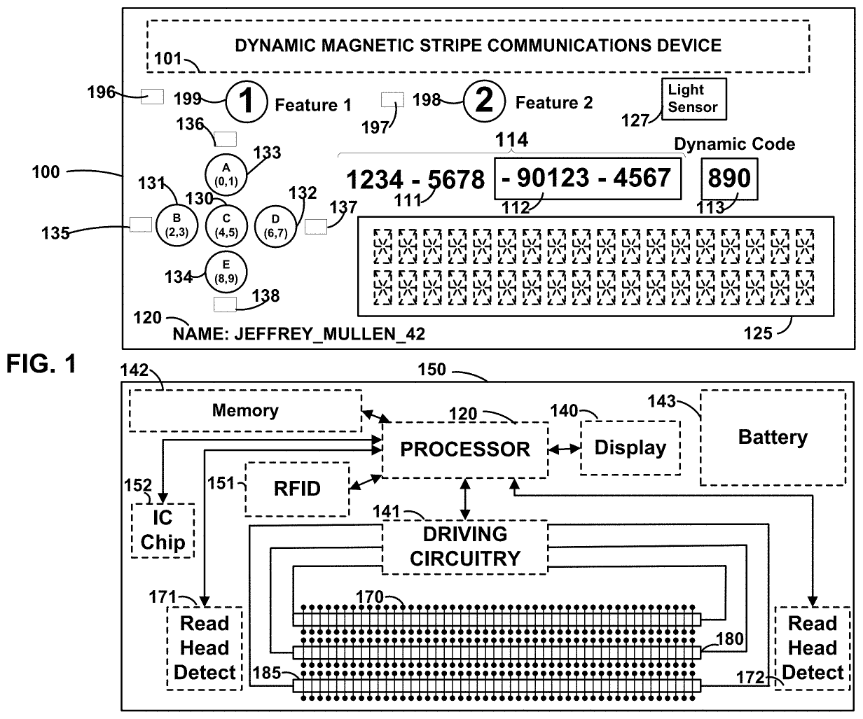

FIG. 1 shows card 100 that may include, for example, dynamic magnetic stripe communications device 101, one or more displays (e.g., displays 112, 113 and 125), permanent information 120, light sensor 127, one or more buttons (e.g., buttons 130-134, 198 and 199), lights 135-138, 196 and 197, and dynamic number 114 which may include a permanent portion 111. Permanent portion 111 may be, for example, printed, embossed and/or laser etched on card 100.

Multiple displays may be provided on card 100 for various purposes. For example, display 112 may display a dynamic number entirely, and/or partially. Display 113 may be utilized to display a dynamic code (e.g., a dynamic security code). Display 125 may display logos, barcodes, and/or one or more lines of information (e.g., may display a coupon code). A display (e.g., at least one of displays 112, 113 and 125) may be a bi-stable display or non bi-stable display. A bi-stable display may be a display that maintains an image without power.

Card 100 may include permanent information 120 including, for example, information specific to a user (e.g., a user's name and/or username) and/or information specific to a card (e.g., a card issue date and/or a card expiration date).

Card 100 may include a dynamic magnetic communications device. Such a dynamic magnetic communications device may take the form of a magnetic encoder and/or a magnetic emulator. A magnetic encoder may change the information located on a magnetic medium such that a magnetic stripe reader may read changed magnetic information from the magnetic medium. A magnetic emulator may generate electromagnetic fields that directly communicate data to a magnetic stripe reader. Such a magnetic emulator may communicate data serially to a read-head of the magnetic stripe reader.

Card 100 may include one or more buttons, for example, buttons 130-134, 198 and 199. Buttons 130-134, 198 and 199 may be, for example, mechanical buttons, capacitive buttons, light sensors and/or a combination thereof.

Button 199 may be used, for example, to communicate information through dynamic magnetic stripe communications device 101 indicative of a user's desire to communicate a single track of magnetic stripe information. Persons skilled in the art will appreciate that pressing a button (e.g., button 199) may cause information to be communicated through device 101 when an associated read-head detector detects the presence of a read-head of a magnetic stripe reader and/or at a specific frequency. Button 198 may be utilized to communicate (e.g., after button 198 is pressed and after a read-head detects a read-head of a reader) information indicative of a user selection (e.g., to communicate two tracks of magnetic stripe data). Multiple buttons may be provided on a card and each button may be associated with a different user selection.

Different third party features may be, for example, associated with different buttons and a particular feature may be selected by pressing an associated button. According to at least one example embodiment, button 198 and button 199 may each be associated with, for example, a different third party service provider feature (e.g., an application facilitating a coupon) and may be changed by a user at any time.

According to some example embodiments, a user may select a third party feature from a list displayed to the user. For example, the user may scroll through a list of features on a display (e.g., display 125). A user may scroll through a list using buttons on a card (e.g., buttons 130-134). The list of features may be displayed to the user individually, in groups and/or all features may be simultaneously displayed.

According to some example embodiments, a third party feature associated with a button may be changed by a user, for example, on a graphical user interface (GUI) provided by a device provider, ecosystem provider, application manager provider, remote facility provider, card issuer, processor, and/or any other entity (which may be the same or different entities). For example, an ecosystem provider may, on its website and/or via an application, allow a user to change the third party feature performed when the third party's feature button is selected by a user on the user's card or other device.

A third party service provider may provide a reward (e.g., a coupon) from a collection of rewards based on, for example, one or more card transactions. The fact the user has received the reward may be presented on a profile page of the user. When a transaction is performed, a user's profile may be updated to state that the user has earned a reward and the user may receive the reward (e.g., via email). A user may be provided with a GUI, for example, a GUI on a mobile telephonic device of the user, when the user makes a purchase, to identify and/or use the reward earned by the user.

The selection of a feature may or may not have a cost associated with it. If a cost is associated with the feature, for example, the cost may be added to a customer's statement (e.g., added to a credit or debit purchase) for a particular transaction. A fixed-fee or variable-fee (e.g., a percentage of the transaction) may then be removed from the fee charged to the user and distributed among particular parties (e.g., distributed to the card issuer, application manager provider, ecosystem provider, device provider and/or other entity) The remainder of the fee, if any, may be provided, for example, to the third party service provider.

A cost may be associated to a feature selection, but may not be a cost to a user. For example, the cost may be a cost to a third party service provider (e.g., an incentive). The cost may be a cost to other entities, for example, the device provider, card issuer, card processor (which may be the same, for example, as the card issuer), and/or any other entity (e.g., card network).

According to some example embodiments, a user may select a type of payment on card 100 via manual input interfaces (e.g., buttons 130-134). The manual input interfaces may correspond to displayed options (e.g., displayed on display 125). Selected information may be communicated to a magnetic stripe reader via a dynamic magnetic stripe communications device. Selected information may also be communicated to a device (e.g., a mobile telephonic device) including a capacitive sensor and/or other type of touch sensitive sensor.

Lights 135-138, 196 and 197 (e.g., light emitting diodes), may be associated with buttons 131-134, 198 and 199. Each of lights 135-138, 196 and 197 may indicate, for example, when a button is pressed. In a case where a button may activate card 100 for communications, a light may begin blinking to indicate card 100 is still active (e.g., for a period of time) while reducing power expenditure. Although not shown, a light may be provided for button 130.

Card 100 may include light sensor 127. Light sensor 127 may, for example, receive information from a light source (e.g., a display of a mobile telephonic device and/or a laptop computer). Card 100 may include, for example, any number of light sensors 127. Light sensor 127 may be utilized such that a display screen, or other light emitting device, may communicate information to light sensors 127 via light. Display 125 may allow a user to select (e.g., via buttons) options on display 125 that instruct the card to communicate (e.g., via a dynamic magnetic stripe communications device, RFID and/or exposed IC chip) to use a debit account, credit account, pre-paid account, and/or point account for a payment transaction.

Architecture 150 may be utilized with any card (e.g., any card 100). Architecture 150 may include, for example, processor 120, display 140, driving circuitry 141, memory 142, battery 143, radio frequency identification (RFID) 151, integrated circuit (IC) chip 152, electromagnetic field generators 170, 180, and 185, and read-head detectors 171 and 172.

Processor 120 may be any type of processing device, for example, a central processing unit (CPU) and/or a digital signal processor (DSP). Processor 120 may be, for example, an application specific integrated circuit (ASIC). Processor 120 may include on-board memory for storing information (e.g., triggering code). Any number of components may communicate to processor 120 and/or receive communications from processor 120. For example, one or more displays (e.g., display 140) may be coupled to processor 120. Persons skilled in the art will appreciate that components may be placed between particular components and processor 120. For example, a display driver circuit may be coupled between display 140 and processor 120.

Memory 142 may be coupled to processor 120. Memory 142 may store data, for example, data that is unique to a particular card. Memory 142 may store any type of data. For example, memory 142 may store discretionary data codes associated with buttons of a card (e.g., card 100 of FIG. 1). Discretionary data codes may be recognized by remote servers to effect particular actions. For example, a discretionary data code may be stored in memory 142 and may be used to cause a third party service feature to be performed by a remote server (e.g., a remote server coupled to a third party service such as a coupon provider). Memory 142 may store firmware that, for example, controls triggering and/or the like.

Architecture 150 may include any number of reader communication devices. For example, architecture 150 may include at least one of IC chip 152, RFID 151 and a magnetic stripe communications device. IC chip 152 may be used to communicate information to an IC chip reader (not illustrated). IC chip 152 may be, for example, an EMV chip. RFID 151 may be used to communicate information to an RFID reader. RFID 151 may be, for example, an RFID tag. A magnetic stripe communications device may be included to communicate information to a magnetic stripe reader. For example, a magnetic stripe communications device may provide electromagnetic signals to a magnetic stripe reader.

Different electromagnetic signals may be communicated to a magnetic stripe reader to provide different tracks of data. For example, architecture 150 may include electromagnetic field generators 170, 180, and 185 to communicate separate tracks of information to a magnetic stripe reader. Electromagnetic field generators 170, 180, and 185 may include a coil (e.g., each may include a coil) wrapped around one or more materials (e.g., a soft-magnetic material and a non-magnetic material). Each electromagnetic field generator may communicate information, for example, serially to a receiver of a magnetic stripe reader for a particular magnetic stripe track. According to at least one example embodiment, a single coil may communicate multiple tracks of data.

Architecture 150 may include read head detectors 171 and 172. Read-head detectors 171 and 172 may be configured to sense the presence of a magnetic stripe reader (e.g., a read-head housing of a magnetic stripe reader). Information sensed by the read-head detectors 171 and 172 may be communicated to processor 120 to cause processor 120 to communicate information serially from electromagnetic generators 170, 180, and 185 to magnetic stripe track receivers in a read-head housing of a magnetic stripe reader.

According to at least one example embodiment, a magnetic stripe communications device may change the information communicated to a magnetic stripe reader at any time. Processor 120 may, for example, communicate user-specific and card-specific information through RFID 151, IC chip 152, and/or electromagnetic generators 170, 180, and 185 to card readers coupled to remote information processing servers (e.g., purchase authorization servers). Driving circuitry 141 may be utilized by processor 120, for example, to control electromagnetic generators 170, 180 and 185.

Architecture 150 may include, for example, a light sensor. Architecture 150 may receive information from a light sensor. Processor 120 may determine information received by a light sensor.

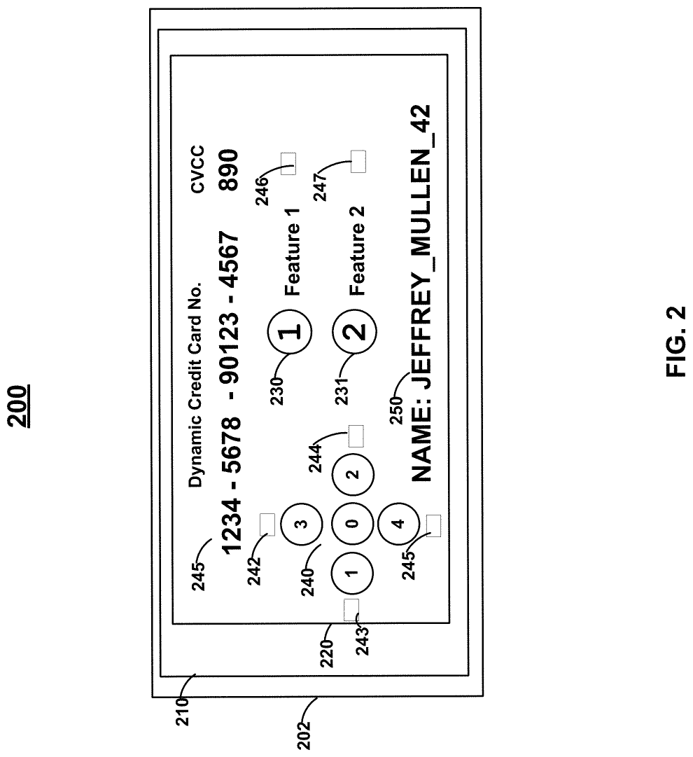

FIG. 2 shows device 200 that may be, for example, a mobile telephonic device and/or other device (e.g., portable computer such as a portable tablet computer). Device 200 may include, for example, housing 202, display 210, device card 220, virtual buttons 230, 231 and 240, virtual lights 242-247, dynamic card number and verification code 245, and identification information 250.

Display 210 may include, for example, light-sensitive and/or touch-sensitive elements. Device 200 may communicate information to a card reader, for example, via a contactless signal (e.g., an RFID signal) and/or a contact-based signal (e.g., a USB connection).

Device 200 may include a device card 220 and/or virtual buttons 230 and 231. Device card 220 may be a virtual representation of a card and/or any information identifying a payment method (e.g., credit account number). A person skilled in the art will appreciate that any physical card described herein may be provided as a device card on, for example, a computing system (e.g., a mobile telephonic device and/or a computer). Physical buttons of a physical card may, for example, correspond to virtual buttons of a device card.

Virtual button 230 may, for example, correspond to one feature (e.g., an opportunity to earn a coupon) from a third party service provider while virtual button 231 may, for example, correspond to another feature (e.g., the opportunity to add value to a coupon) from the same or a different third party service provider. According to at least one example embodiment, every feature may not be provided by a third party service provider. Persons skilled in the art will appreciate that, for example, the device provider may provide features.

All features for a card may be utilized with a particular payment account (e.g., a credit account) such that a payment transaction with that payment account is performed if any feature is selected. As another example, one or more features may be associated with a payment account (e.g., a credit account) while an additional one or more features may be associated with a different payment account (e.g., a debit account). Accordingly, a selected feature associated with a credit account may be utilized to make a purchase with credit and may perform an additional action associated with that feature. A different selected feature associated with a debit account may be utilized to make a purchase with debit and may perform an additional action associated with that different feature.

Device 200 may include virtual lights 242-247. Virtual lights 242-247 may, for example, indicate an active period during which device 200 may communicate with external devices. Virtual lights 242-247 may correspond to, for example, virtual buttons 230, 231 and 240. According to example embodiments, a fewer or greater number of virtual lights are contemplated (e.g., a center button of virtual buttons 240 may virtually light up).

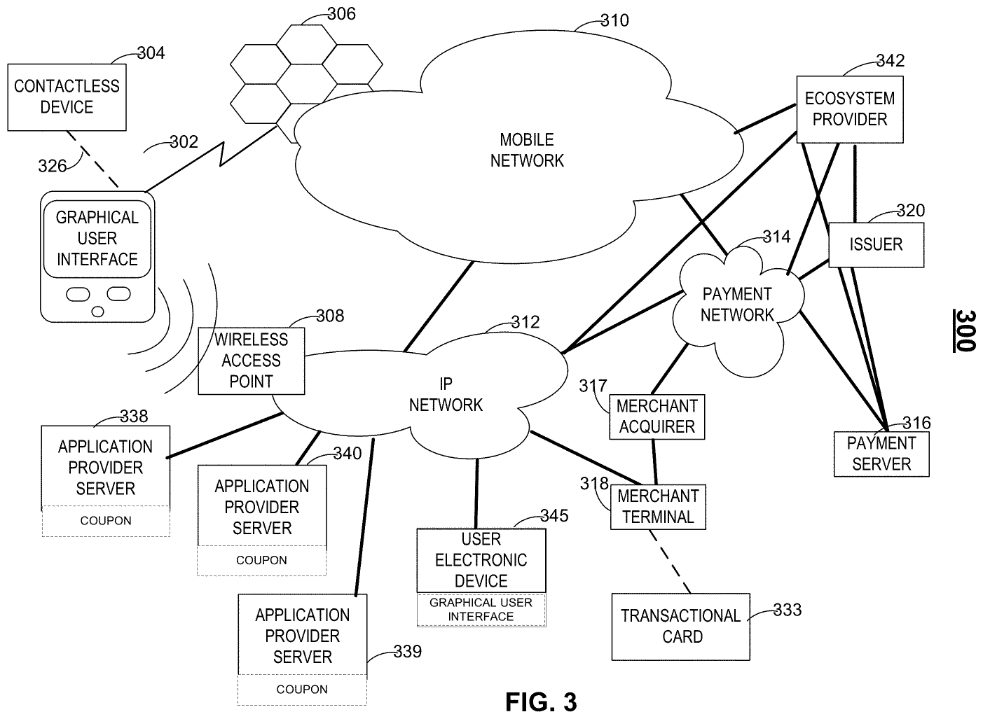

FIG. 3 shows network topology 300 that may include, for example, mobile device 302, contactless device 304, cellular network access infrastructure 306, mobile network 310, wireless access point 308, IP network 312, payment network 314, issuer 320, payment server 316, merchant acquirer 317, ecosystem provider 342, merchant terminal 318, transaction card 333, user electronic device 345 and/or application providers 338, 339 and 340.

Mobile device 302 (e.g., a mobile telephonic device, a PDA, an electronic tablet, a laptop, a GPS unit, and/or an MP3 player) may include, for example, a contactless interface that may initiate, sustain, and/or terminate communication channel 326 between contactless device 304 (e.g., a powered card, non-powered card and/or a device) and mobile device 302. Contactless device 304 and mobile device 302 may communicate via channel 326 using any number of contactless mediums, which may include for example, visible, audible, capacitive, electromagnetic, magnetic, and/or RF mediums.

Mobile device 302 may provide one or more transceivers, receivers and/or transmitters that may communicate with one or more wired networks (e.g., IP network 312 and/or payment network 314) and/or one or more wireless networks (e.g., a mobile network 310). Mobile device 302 may, for example, communicate with a cellular station over a wireless radio interface (e.g., a GSM air interface) that may be used by mobile device 302 to communicate information (e.g., voice and data) to cellular network access infrastructure 306 (e.g., one or more GSM base transceiver stations, base station controllers and mobile switching centers). Persons skilled in the art will appreciate that cellular network access infrastructure 306 may utilize any multiple access architecture, such as for example, a code-division multiple access architecture and/or a time-division multiple access architecture.

Mobile device 302 may, for example, communicate with wireless access point 308 over a wireless interface (e.g., a Bluetooth interface or a Wi-Fi interface). Accordingly, for example, mobile device 302 may access one or more wired networks (e.g., IP network 312 and/or payment network 314) and/or one or more wireless networks 310 (e.g., a mobile network) without the need to first gain access to cellular network access infrastructure 306.

Payment information (e.g., a payment account number and a card expiration date) may be communicated from contactless device 304 to mobile device 302 in support of a transaction (e.g., a financial transaction) being conducted by mobile device 302. In so doing, for example, items for purchase on IP network 312 (e.g., the internet) may be accessed by a browser of mobile device 302 via an access point (e.g., wireless access point 308 and/or cellular network access infrastructure 306). Mobile device 302 may, for example, complete a purchase transaction by first obtaining required payment information from contactless device 304 and then communicating such payment information to network entities (e.g., merchant acquirer 317, payment server 316 and/or issuer 320). Mobile device 302 may, for example, already contain payment information necessary to complete a purchase transaction. Accordingly, mobile device may not need to obtain payment information from contactless device 304 before completing a purchase transaction.

Payment server 316 may, for example, contact issuer 320 via a network (e.g., payment network 314) with payment information received from mobile device 302 for authorization of a purchase. Once authorized, payment transaction information may be recorded onto a receipt that may be delivered to mobile device 302 via any one or more delivery options (e.g., via a short messaging service of mobile network 310 or an email delivery service of IP network 312).

A payment receipt may, for example, be provided to mobile device 302 as a proof-of-purchase object (e.g., a barcode) that may be provided to a display of mobile device 302 and read by other computing equipment (e.g., a barcode scanner) for proof-of-purchase confirmation.

Transaction card 333 (e.g., a powered card, non-powered card and/or device card) may, for example, communicate information to merchant terminal 318 (e.g., a magnetic stripe reader, an EMV reader, an RFID reader, an NFC reader and/or a swipe reader attached to an electronic device). Merchant terminal 318 may begin transactions (e.g., point-of-sale transactions) and/or complete transactions via merchant acquirer 317 and/or payment network 314. Accordingly, for example, transaction card 333 may communicate payment information to merchant terminal 318 to initiate a financial transaction.

Merchant terminal 318 may communicate transaction information, including at least a portion of the payment information, to merchant acquirer 317. Merchant acquirer 317 may authorize the financial transaction and/or communicate with payment server 316. Payment server 316 may, for example, contact issuer 320 via a network (e.g., payment network 314) with transaction information received from merchant acquirer 317 for authorization of a purchase. Once authorized, an authorization may be communicated to merchant terminal 318 and may be recorded onto a receipt by merchant terminal 318.

Application providers 338, 339 and 340 may be one or more entities (e.g., one or more servers) providing applications for association in an ecosystem provided by ecosystem provider 342. Each application may provide one or more features to users of a payment method (e.g., users of contactless device 304 and/or transaction card 333). For example, an application may provide a user an opportunity to earn a coupon and/or add value to a coupon in exchange for using the payment method. According to at least one example embodiment, application provider 338 may provide coupons as part of a loyalty or rewards program, which may be independent of any payment method. Ecosystem provider 342 may be, for example, a server that maintains associations between applications, users and payment methods.

Ecosystem provider 342, and application providers 338, 339 and 340, may communicate with different entities using one or more wired networks (e.g., IP network 312 and/or payment network 314) and/or one or more wireless networks 310 (e.g., a mobile network). Application providers 338, 339 and 340 may communicate directly and/or indirectly with different entities. For example, merchant terminal 318 and/or ecosystem provider 342 may communicate directly with application providers 338, 339 and 340 via IP network 312 and/or via a direct connection (e.g., to validate coupons with a coupon server). As another example, application providers 338, 339 and 340 may exchange information (e.g., transactional data) indirectly with issuer 320, merchant acquirer 317 and/or payment network 314 via, for example, ecosystem provider 342.

A user electronic device (e.g., mobile device 302 and/or a wired user electronic device 345) may display a GUI. The GUI may be an application manager used to interface with ecosystem provider 342, and application providers 338, 339 and 340, to define user preferences. Defining user preferences may include, for example, configuring associations (e.g., between users, applications and payment methods), features and/or permissions.

In order to configure associations, the GUI displayed on the user electronic device may, for example, display indicia representing applications that provide features. A user may associate one or more of the applications to one or more payment cards and/or payment card buttons (e.g., mobile device 302 and/or transaction card 333)).

In order to configure one or more features provided by an application, the GUI displayed on the user electronic device may be used to, for example, interface with one or more of application providers 338, 339 and 340. For example, using the GUI, a user may select a coupon from among multiple coupons provided by an application hosted by an application provider.

In order to configure associations, a user may use the GUI displayed on the user electronic device to define how payment network 314, ecosystem provider 342, one or more of application providers 338, 339 and 340, and third-party applications hosted by the one or more application providers (or any other application providing entity) interact for transactions conducted by the user.

For example, a user may accept an end license user agreement that outlines how data may be shared between entities. As another example, a user may define what data may be shared between entities. For example, where data (e.g., transactional data) may be provided to ecosystem provider 342 by payment network 314, and/or provided to one or more of application providers 338, 339 and 340 by ecosystem provider 342, a user may select at least a portion of data provided to ecosystem provider 342 by payment network 314, and select at least a portion of data to be shared with the one or more of application providers 338, 339 and 340.

Prior to presenting transaction card 333 to merchant terminal 318 to initiate a transaction, a customer may select (e.g., via one or more button presses on a powered card and/or device card) an application to be associated to the transaction. Based on the selection, one or more additional actions may be taken besides the processing of the transaction by payment network 314. For example, a user may press a button on a powered card (e.g., transaction card 333). Upon presenting transaction card 333 to merchant terminal 318, a payment message (e.g., a magnetic stripe message) reflecting the button that was pressed may be communicated to merchant terminal 318. Merchant terminal 318 may communicate a data string including the payment message and transaction information to payment network 314 via merchant acquirer 317.

Payment network 314 may receive the data string. The data string may include a directive instructing payment network 314 to share data with ecosystem provider 342. According to at least one example embodiment, payment network 314 may share data with ecosystem provider 342 upon receiving the data string and recognizing, based on at least a portion of the data string (e.g., an account number), that data is to be shared. Payment network 314 may cause the same or a different data string to be communicated from payment network 314 (e.g., from a processor within payment network 314) to ecosystem provider 342.

Although example embodiments describe a payment network communicating data to an ecosystem provider, alternatively and/or additionally, an issuer and/or a processor of an issuer may receive data and communicate at least a portion of the data and/or different data based on the received data to ecosystem provider 342. For example, a processor of issuer 320 may parse a data string received from merchant terminal 318 (e.g., via payment network 314) that includes a particular BIN number, may convert the data string into a different format and may forward the converted data string to ecosystem provider 342. Persons of ordinary skill in possession of example embodiments will appreciate that many different messaging schemes may be used.

Ecosystem provider 342 may receive the data string and compare user information (e.g., payment account number and/or payment account holder's name) that may be included within the data string to a user database to obtain a customer ID (e.g., a customer token) associated with the user information.

According to at least one example embodiment, sensitive information within the data string (e.g., payment account number and/or payment account holder's name) may be replaced with the customer ID to create a modified data string, and the sensitive information may be stored either locally within ecosystem provider 342 or remotely to ecosystem provider 342. The modified data string may be communicated to a third party application (e.g., one or more of application providers 338, 339 and 340) via, for example, IP Network 312.

According to at least one example embodiment, ecosystem provider 342 may receive the data string. The data string may be populated with information that may be indicative of which button was pressed on the powered card before being presented to merchant terminal 318. Using the button information and user preferences, ecosystem provider 342 may generate a third-party message with details that may be shared with a third-party application (e.g., one or more of application providers 338, 339 and 340). The generated data string may include the customer ID and may be communicated to a third party application (e.g., one or more of application providers 338, 339 and 340) via, for example, IP Network 312.

A user may elect to share certain transaction information with one or more of application providers 338, 339 and 340 each time a certain button is pressed on the user's powered card before presentment to merchant terminal 318 for payment. Such information may include, for example, merchant information (e.g., merchant's address), date/time information of a purchase, an amount of the purchase, a type of the purchase, and any other information (e.g., the customer ID associated with the customer's merchant account). The various pieces of the transaction information may or may not be selected for sharing by the user via the user preferences.

According to at least one example embodiment, a user may agree to share data during a registration process with an application provider (e.g., via an end user license agreement). Upon receiving a data string, the sharable data may be automatically populated within a third-party message and communicated to an application provider via IP network 312.

Upon receipt of the third-party message, the application provider (e.g., one or more of application providers 338, 339 and 340) may enact a feature provided to a user (e.g., provide a coupon). The application provider may initiate a second transaction (e.g., a piggyback transaction, a statement credit and/or the like). The second transaction may be communicated to ecosystem provider 342 via IP network 312 (e.g., the internet) and processed by ecosystem provider 342 accordingly. For example, ecosystem provider 342 may determine whether a second transaction is permitted and/or forward information associated with the second transaction to another entity (e.g., issuer 320).

According to some example embodiments, a GUI may, for example, be rendered onto a display of a user's card or other device (e.g., mobile device 302, user electronic device 345, transaction card 333 and/or contactless device 304). The GUI may display indicia of one or more third-party applications (e.g., provided by one or more application providers 338, 339 and 340) along with summary and/or detailed information. Based upon information gleaned from the information concerning the applications, the user may be better informed as to which third-party applications he or she may wish to associate with his or her powered or non-powered card. Accordingly, the whimsical and festive nature of a user's experience with a GUI rendered by an electronic device may be further enhanced.

According to example embodiments, an application provider may be any entity. For example, ecosystem provider 342 may be an application provider in addition to providing an ecosystem. According to at least one example embodiment, an application provider may be a third-party application provider and ecosystem provider 342 may host the third party application (e.g., provide coupons). Data sharing may be the same or different based on a particular configuration.

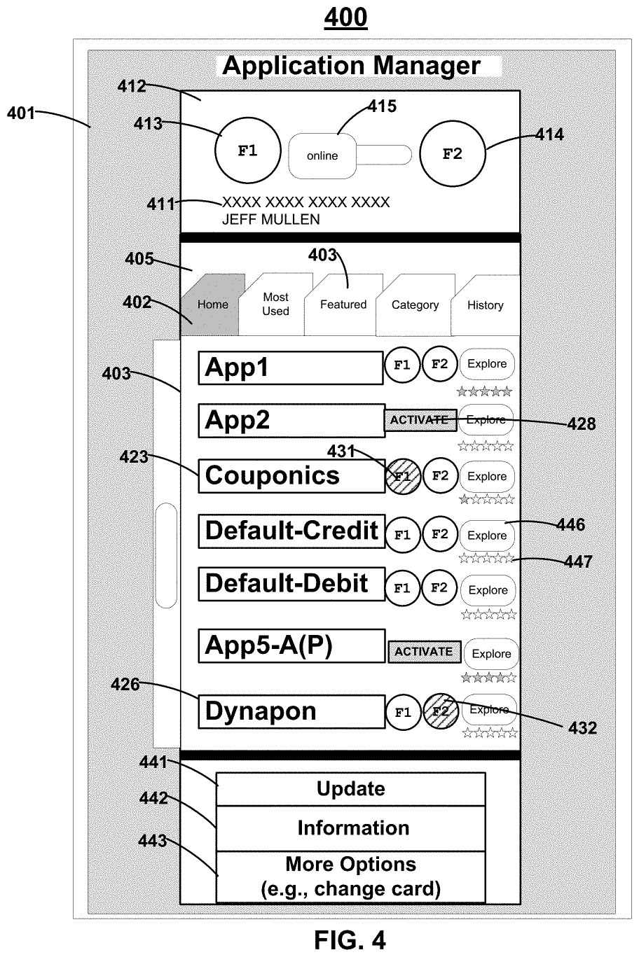

FIG. 4 shows device 400 (e.g., a card, a mobile telephonic device, a laptop computer, a desktop computer or an electronic tablet) that may include display 401. Device 400 may include a processor that may render GUI 403 onto display 401. GUI 403 may be an application manager. Using GUI 403, a user may associate a payment method card (e.g., a powered physical card, non-powered physical card and/or device card) with third party service features within an ecosystem. GUI 403 may be displayed on display 401, for example, a computer monitor, mobile phone touch screen and/or the like. GUI 403 may be, for example, provided as an application for a device (e.g., a computer, a portable computing device and/or a mobile telephonic device) and/or retrieved information from a web browser.

An application manager may be provided, for example, on a remote facility and displayed via GUI 403 to allow a user to change the third party service features associated with a card. An application manager may manage an ecosystem of applications and payment method cards, and the user may utilize GUI 403 to, for example, associate a particular feature to a particular payment method card at any time. The user may associate the selected feature with a card and/or a card button.

Persons skilled in the art will appreciate that a default feature may be provided and/or that a number of features provided by a card issuer or other entity may be provided in addition to third party service features. For example, a card issuer may provide a card with a default of credit on one button and a default of decoupled debit on a second button. A user may press the first button to perform a credit transaction. A user may press the second button to perform a decoupled debit transaction.

GUI 403 may include tabs 405, information 411, virtual card 412, virtual indicia 413 and 414, slider 415, application identifiers 423 and 426, and selection options 428, 431, 432, 441-443 and 446.

Virtual card 412 may be provided as a representation of a user's physical and/or device card. A user may be provided with the ability to change between multiple different cards and configure the features associated with those multiple cards. Accordingly, virtual card 412 may be provided with indicia 413 in the configuration of, and indicative of, one button of a user's card, and virtual card 412 may be provided with indicia 414 in the configuration of, and indicative of, another button of a user's card. Indicia 413 and 414 may display the applications currently associated to each button (e.g., an application icon). A slider 415 may be provided to indicate which of applications associated with a button may be a default application (e.g., for online, telephonic and/or non-powered card transactions). Accordingly, a user may, for example, view virtual card 412 in order to refresh the user's memory with respect to the features associated with the buttons on a user's physical and/or device card.

A list of applications may be provided on GUI 403. Each application may provide one or more third party service provider features. In order to associate a particular feature with a particular card and/or one or more buttons on a card, a user may associate an application providing the feature to the card and/or card button(s). For example, selection 431 may associate application 423 to the button of a card associated with virtual button 413. Selection 432 may associate application 426 to the button of a card associated with virtual button 414. Accordingly, a user may change the features associated to a card by using GUI 403. In order to view the features provided by a particular application the user may, for example, select an “explore” button to view relevant information (e.g., selection 446).

The list of applications provided on GUI 403 may be, for example, all applications or a limited subset of all applications available to a user via an ecosystem provider. For example, in order to view all available applications, tab 402 may be selected by a user (e.g., with a keyboard, mouse, touch sensitive screen and/or electronic pointer) to display an application manager home view. In order to view a limited subset of applications a user may select a different tab. For example, tab 403 may be selected by a user to display a featured view including featured applications (e.g., applications-of-the-week). Other tabs may sort applications by category, use and/or the like.

Selections 428 may be selections used to activate an application with respect to the user. Activation may include registration with a third party application, acceptance of an end users license agreement associated with the application, and/or the like. Activation may also include selecting a particular feature from among multiple features provided by the application. According to at least one example embodiment, some applications may not require activation (e.g., single feature, non-interactive applications).

Once an application is activated and/or associated to a card and/or card button, a user may begin experiencing a selected feature by engaging in card transactions. For example, the user may press a card button associated with a desired feature during a card transaction. A physical and/or device card (not shown) may communicate information indicative of a button that was pressed on the physical and/or device card, along with or separate from other payment data (e.g., an account number, security code, and other data). For example, information indicative of the button that was pressed may be included in discretionary data of a payment message. A payment message may be, for example, one or more tracks of magnetic stripe data (e.g., communicated from a dynamic magnetic stripe communications device), an RFID message (e.g., a near field communication (NFC) message from a radio frequency antenna), and/or an exposed IC chip message (e.g., an EMV message) from an exposed IC chip.

The information indicative of which button was pressed may be passed to a card issuer and/or processor from a point-of-sale and any intermediary devices (e.g., a merchant acquirer processing server). The information may be passed to a remote facility (e.g., a facility providing an application manager) such that the remote facility may determine the button that was pressed by a user. This remote facility may, in turn, retrieve information associated with the third party feature (and/or a feature of a card issuer, processor, application manager provider, and/or any entity) and forward information to that feature provider such that the feature may be performed. Information may additionally and/or alternatively be provided from the feature provider to the entity that provided the information indicative of the button that the user pressed.

Persons skilled in the art will appreciate that if, for example, a non-powered card is utilized then information indicating that a button was pressed may not be available. With respect to a non-powered card, information indicative that a purchase was made may be provided to an application manager provider such that the application manager provider can initiate the desired feature for the non-powered card. For example, the feature may be a default feature, a selected feature (e.g., selected using an application manager) and/or a random feature.

For non-powered cards, for example, features may be associated with different types of purchases. For example, one feature may be provided for a particular merchant type (e.g., a grocer's coupon) and another feature may be provided for a different merchant type (e.g., a clothing store coupon). Features may be associated with other characteristics of a purchase such as, for example, a purchase above a particular amount (e.g., at or above $100) and/or a purchase below a particular amount (e.g., below $100). However, such additional feature selections are not limited to non-powered cards and may be provided to, for example, users of powered cards and devices.

According to example embodiments, any feature and/or capability not requiring a powered device (e.g., a computing device such as a powered card and/or mobile telephonic device) may be implemented with respect to a non-powered card and any feature and/or capability of a non-powered card may be implemented with respect to a powered card. According to at least one example embodiment, features and/or capabilities requiring a powered card may be implemented with respect to a non-powered card in various ways. For example, additional functionality may be provided at merchant terminals.

GUI 403 may be provided, for example, on a card issuer's and/or application manager provider's website. GUI 403 may be provided, for example, on a bill statement web page. Accordingly, a user may utilize the application manager to manage application features when the user is logged into his/her account. Although example embodiments described with respect to FIG. 4 may describe a GUI 403 used to make various selections and/or associations, persons skilled in the art will appreciate that other methods are possible. For example, selections may be made by phone, email and/or the like.

A third party service provider may utilize GUI 403 as part of a user's administration and/or experience of that third party service. For example, a user's profile page for a third party service may include GUI 403. An application manager provider may provide web-code that retrieves GUI 403 from a remote facility managed by the application manager provider and/or other entity (e.g., issuer, merchant acquirer, payment network, merchant and/or the like). Selection 441 may be utilized by a user to check for updates (e.g., confirm that a feature was changed and/or if any updates are present). Selection 442 may be utilized to explain the functionality of a particular application feature. Selection 443 may be utilized for additional selection options, for example, changing which card is displayed on an application manager.

According to at least one example embodiment, a card may be provided with one button for a particular payment account (e.g., credit) and one button for a changeable feature. Accordingly, a user may, for example, only need to remember one feature associated with a card. A credit account may include rewards, for example, points, cashback, and/or miles, from the card issuer. Accordingly, pushing the payment account button may earn the user such rewards. Pushing the changeable feature button may, alternatively, for example, not earn the user such rewards and may instead initiate a changeable feature. In doing so, for example, the cost of providing a card may be reduced in that the cost of rewards for the card may be reduced. A feature may include, for example, a feature from a third party application provider. The feature from the third party application provider may be, for example, a random reward (e.g., a random coupon).

Information 411 may, for example, identify the user and card number associated with virtual card 412 and a corresponding physical card. One or more of tabs 405 may provide, for example, a history of purchases made by a user. An application manager may provide indicia reflecting a user rating (e.g., star rating 447).

According to example embodiments, an ecosystem provider may be the same or different from an application manager provider, a remote facility and/or other entities. One or more of the functions described herein as being performed by an application manager provider, and/or other entities, may be performed by the ecosystem provider. According to at least one example embodiment, an ecosystem provider may act as an application manager provider, application provider, issuer, merchant, third party service provider, payment network and/or the like to provide an end-to-end experience. In general, example embodiments contemplate the same, greater and/or fewer entities, and specific entities are described for purposes of explanation.

One of ordinary skill in the art will appreciate that GUI 403 is provided for purposes of illustration only and may take various forms. For example, features may be associated to a card without buttons and/or a card may include the same, fewer and/or a greater number of buttons than depicted in FIG. 4.

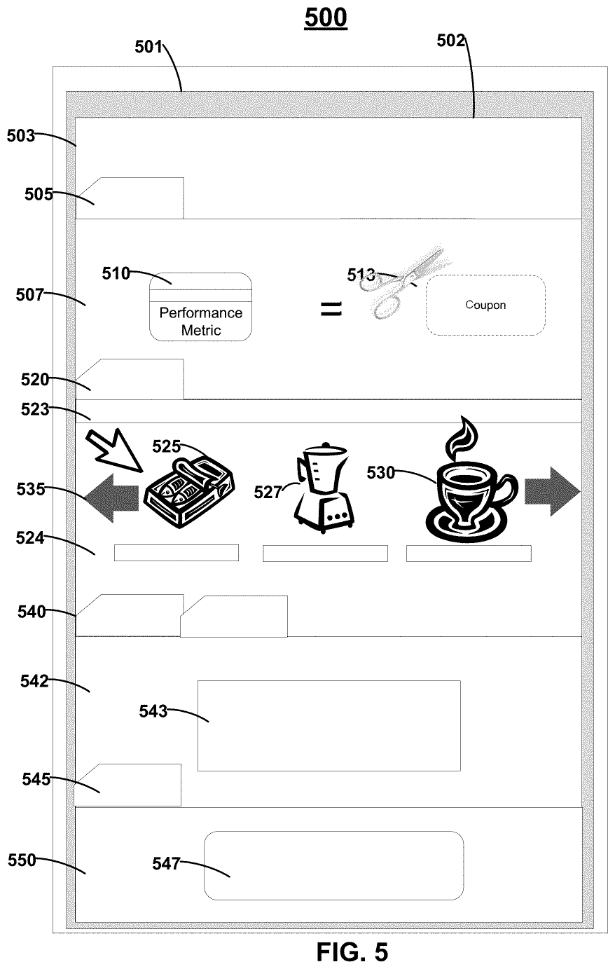

FIG. 5 shows device 500 (e.g., a card, a mobile telephonic device, a laptop computer, a desktop computer or an electronic tablet) that may include display 501. Device 500 may include a processor that may render GUI 502 onto display 501. GUI 502 may be an application interface usable to manage a user's experience with an application. GUI 502 may be used to, for example, configure application settings, receive information from an application provider, and/or communicate information to an application provider.

GUI 502 may include, for example, application screens 503, 507, 524, 542 and 550, tabs 505, 520, 540 and 545, information displays 510, 513, 523, 525, 527, 530 and 543, and selections 535 and 547.

Information display 503 may include, for example, information related to an application provider. For example, information display 503 may display the name and a brief history of the application provider.

Tab 505 may be used to display application screen 507 and may include a descriptor associated with application screen 507 (e.g., “How It Works”). Although example embodiments may be described with respect to tabs, persons skilled in the art will appreciate that tabs are used for purposes of explanation only. For example, redirection links may be provided to redirect a user to a configuration screen of an application provider. According to at least one example embodiment, tab 505 may be an information display without tab functionality.

Application screen 507 may be a configuration and/or informational screen for an application, and may display information explaining a feature provided by the application. For example, application screen 507 may include information indicating that a coupon will be provided to a user once the user meets or exceeds a performance metric.

A coupon may be, for example, a voucher entitling a user to a discount and/or a rebate. The discount and/or rebate may be associated with a particular product, a purchase from a particular vendor and/or the like. A performance metric may define, for example, a transactional event. For example, a performance metric may include a purchase with a card (e.g., a physical and/or device card), a sequence of purchases (e.g., ten purchases) with a card, and/or spending a target amount with a card. Any purchasing and/or non-purchasing transactional event is contemplated by example embodiments. For example, a performance metric may involve a rate of transactions (e.g., checkout 5 books from a library in 10 minutes), a pattern of transactions (e.g., purchase 10 different items from 10 different stores), a target transaction (e.g., purchase a particular item) and/or the like.

Application screen 507 may include information displays 510 and 513. Information display 513 may include a representation of a type of reward, for example, an image representing a coupon. Information display 510 may display a representation of a performance metric, for example, a monetary value and a payment method. Accordingly, for example, application screen 507 may indicate that a user of a payment method (e.g., a powered card) may receive a coupon and/or increase the value of a coupon each time the user spends an amount indicated in information display 510 using the payment method indicated in display 510.

A coupon provided by an application provider may be selected in various ways. For example, a coupon may be randomly selected, may be selected by a user (e.g., from a list of coupons) and/or may be selected based on transactional information (e.g., data related to a purchase, a user purchase history and/or the like). The coupon may be selected prior to or after completion of the performance metric.

Each coupon may have a face value (e.g., a normal coupon value) and may be increased in value based on a value of the performance metric (e.g., a value to the application provider). For example, where a performance metric includes spending $100, $200 or $300, a value of the coupon may be 200% at the $100 level, 400% at the $200 level and 800% at the $300 level. A user may or may not select a level of the performance metric (not shown).

Tabs 520 may be used to display application screen 524. Application screen 524 may include, for example, information displays 525, 527 and 530, and selections 535. Information displays 525, 527 and 530 may, for example, display representations of redeemable coupons earned by a user. Selection 535 may be used to change one or more of the coupon representations displayed in application screen 524 (e.g., to cycle through available coupons). A user may, for example, select one of the representations to use the associated coupon for a specific purchase. Additionally and/or alternatively, the coupon may be applied at any time the coupon is usable according to a user selection and/or by default (e.g., a coupon applied to the purchase of a specific product and/or in a specific store as a default).

Each of information displays 525, 527 and 530 may display information associated with a coupon in addition to, or alternatively to, the representation of the coupon. For example, the information may include a description of the value provided by the coupon, a description of added value to a base value of the coupon, an expiration date of the coupon and/or any other coupon related information (e.g., within the representation and/or beneath the representation). According to at least one example embodiment, each representation of a coupon may be a progress meter. According to some example embodiments, a user may build a coupon by selecting various information (e.g., base value, added value, expiration date and/or the like).

Tabs 540 may include one or more tabs used to display one or more application screens 542. One of tabs 540 may be used to select an application screen including an information display listing earned coupons. For example, each of information displays 525, 527 and 530 may be selections representing categories of coupons. A user may select information display 525 to display, for example, a list of earned coupons related to food in information display 543. A user may select information display 527 to display, for example, a list of earned coupons related to small appliances in information display 543. A user may select information display 530 to display, for example, a list of earned coupons related to prepared beverages in information display 543.

According to some example embodiments, a list of earned coupons may also include, for example, unearned coupons. The unearned coupons may be visually distinguishable from the earned coupons (e.g., a different color and/or shading). Each displayed coupon may be, for example, a selection that may be used to begin earning the coupon, retrieve information associated with the coupon and/or the like. According to some example embodiments, more than one of information displays 525, 527 and 530 may be selected simultaneously.

One of tabs 540 may be selected to display a redemption history in information display 543. A redemption history may, for example, display a purchase description and an amount saved. As another example, one of tabs 540 may be selected to display a transaction history. A transaction history may include, for example, information indicating a type of transaction (e.g., purchase), an amount spent, a date of the transaction and/or line items indicating that one or more coupons have been earned in relation to the transaction.

Tab 545 may selected to display application screen 550. Application screen 550 may include selection 547. Upon selecting selection 547, a user (having met a performance metric) may activate an earned coupon. As one example, a user may select a coupon from among multiple, available coupons and then press selection 547 to render the selected coupon usable. As another example, the application provider may randomly select a coupon earned by the user and the user may press selection 547 to render the randomly determined coupon usable. Selection 547 may include an information display (e.g., “$40 spent, press to redeem for coupon”). According to at least one example embodiment, selection 547 may not be included and a coupon may be automatically activated by the application provider (e.g., based on user settings).

A user may be notified by an application provider when a coupon is earned and/or additional value is added to the coupon. The application provider may utilize user submitted notification settings to notify the user. Once notified, a user may activate a coupon for a particular purchase and/or for any purchase (e.g., to be used when applicable). Once a coupon is activated, the user may initiate a purchase using a payment method (e.g., powered card) and an activated coupon may be associated to the purchase (e.g., manually and/or automatically associated to the purchase). For example, an application provider may receive transactional data indicating a type of product and/or a location of a purchase, search a list of coupons earned by a user and associate any applicable coupons to the purchase based on the transactional data. If any coupons are associated to the purchase, value may be provided to the user (e.g., via a statement credit), for example, immediately, at authorization, at settlement and/or in a number of days. Alternatively or additionally, the application provider may attach the coupon and/or a number associated with the coupon, for example, to an email. A user may print the coupon and/or use number associated with the coupon (e.g., for an internet purchase).

Persons of ordinary skill in possession of example embodiments will appreciate that many different notification and reward fulfillment methods may be used. For example, a user may be notified of a reward or receive a reward via email, telephonic data transfer (e.g., text messaging), telegram and/or the like. According to at least some example embodiments, no notification may be provided and/or a user may be required to retrieve a coupon (e.g., via a GUI). According to at least one example embodiment, a coupon may be transmitted to a user's powered card and the powered card may be operable to display a barcode usable at, for example, a retail establishment.

A selection may be included to activate functionality by which outright purchases of a coupon and/or contributions towards a coupon may be made (not shown). Purchases and/or contributions may be made using, for example, piggyback charges, third party charges, direct purchases and/or the like.

A piggyback charge may be a statement debit (charge) added to a user statement, for example, for each purchase using a card and/or a device card. A user may select an amount and/or frequency of the piggyback charge using, for example, GUI 502 (not shown). According to at least one example embodiment, a user may earn a coupon and/or increase the value of a coupon for each piggyback charge.

A third party charge may be a monetary value provided by an application provider, for example, upon a user meeting an incentive performance metric in addition or alternatively to using the payment method (e.g., making purchases at a specific store and/or buying a specific product). A direct purchase may be a partial or complete purchase of a feature by a user that is not attached to any other purchase. For example, a vendor may provide functionality by which a user may swipe a card and/or otherwise communicate data of a card to partially or wholly purchase a coupon without also purchasing any item from the vendor.

According to some example embodiments, a user may configure an application using GUI 502 to earn coupons and/or add value to coupons not included as a default selection on GUI 502. For example, GUI 502 may include a blank information display (not shown). A feature provider may provide ‘drag-and-drop’ coupon icons (e.g., on a feature provider website) representing the reward. A user may drag the icon onto GUI 502 and GUI 502 may be automatically modified to include the coupon. The icon transfer may include feature provider information, for example, information invisible to a user that may be used by an application. The coupon provider may provide special incentives for a limited time (e.g., Black Friday), as a customer acquisition tool, as a customer retention tool, and/or the like. The coupon may be a unique coupon not available outside of an ecosystem.

As one non-limiting example, GUI 502 may display a configurable coupon application. A user may select from coupons provided by different retail outlets. The user may drag an icon from a webpage of a particular retail outlet onto the configurable application. The user may drag an icon from a webpage of a different retail outlet onto the configurable application. Both icons may appear on the configurable application. Accordingly, an application may not be limited to a specific retailer and/or coupon provider, and may enhance the whimsical and festive nature of a feature provided to a user.

An application accessed using GUI 502 may include configurable functionality to improve a user experience. For example, a representation of each coupon earned by the user may be publically and/or privately displayed when earned (and/or a progression display may be updated). For example, coupon information may be displayed on a user's social networking page, on a physical display at chosen location and/or the like. In order to provide configurable functionality, an application provider and/or an application of an application provider may be associated to the user during, for example, an activation process. A user requesting access to an application may be prompted for information. The information may include, for example, security credentials used to access a social networking site associated with the user.

Selections may, for example, activate an additional and/or alternative feature. For example, a selection (not shown) may be used to pay an amount corresponding to completion of the performance metric displayed in information display 510. As one example, if a user is required to spend $100 to earn a coupon, the value of the feature is $10, and the user has spent $50 using the payment method, the user may pay the coupon provider $5 (the difference in value). The amount may be, for example, immediately charged via GUI 502 and/or may be attached as a piggyback charge to a purchase (e.g., a next purchase using a card and/or a device card). Accordingly, a user may take advantage of limited time offers even where the user does not expect to complete a performance metric within the limited time. The whimsical and festive nature of a coupon application may therefore be enhanced.

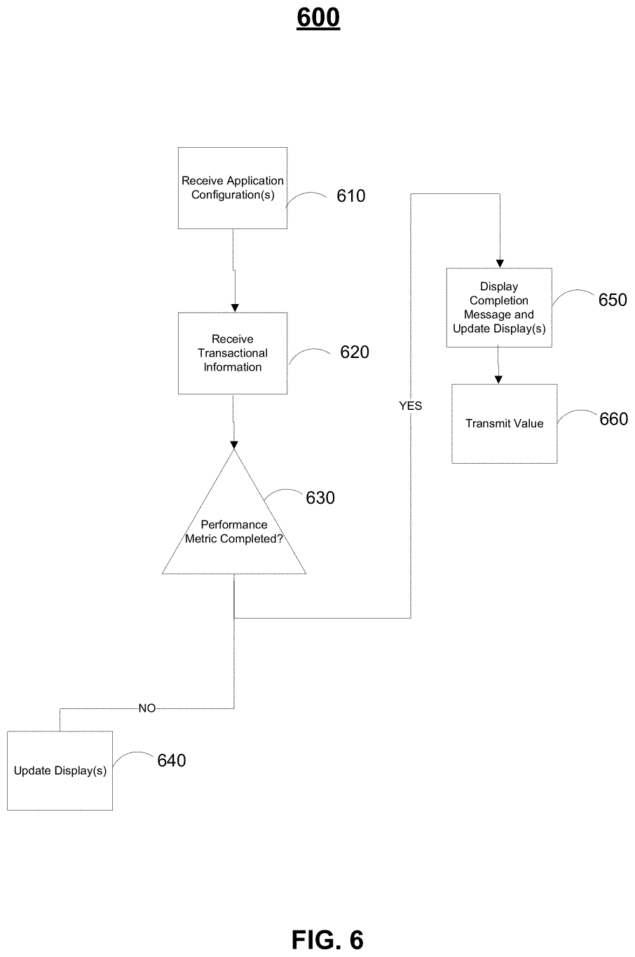

FIG. 6 shows process flow chart 600. An application provider may receive user configuration selections (e.g., as in step 610) and transactional data from, for example, an application manager provider (e.g., as in step 620). The application provider may associate the transactional data with a user and determine if a performance metric has been completed (e.g., as in step 630). If a performance metric has not been completed, the application provider may update one or more information displays based on the received transactional data (e.g., as in step 640). If a performance metric has been completed, the application provider may display a completion message to a user and update one or more information displays (e.g., as in step 650). A value (e.g., coupon) may be transmitted to, for example, the payment method user (e.g., as in step 660).

According to one non-limiting example embodiment, a coupon provider may receive a user feature selection. The coupon provider may receive transactional information, for example, information indicative of a feature selected by a user (e.g., via a telephone device card, powered card and/or the like) and transactional information related to a payment card (e.g., a number of transactions performed by the user with the payment card, an amount spent and/or the like). Based on the information, the coupon provider may determine if a performance metric has been completed. For example, a performance metric may include ten user purchases using a powered credit card. If the user has not completed ten purchases using the powered credit card, a progression display (e.g., a progress meter) may be updated (e.g., if applicable). If the transactional metric has been met, an email may be sent notifying the user that the coupon has been earned. One or more progression displays may be updated and the coupon may be communicated to the user. According to at least one example embodiment, the notification and coupon may be communicated to the user in the same email message.

According to at least one example embodiment a coupon code may be communicated to the user. According to at least one other example embodiment, a user may be notified that a coupon code and/or a coupon is available electronically (e.g., accessed from an application manager).

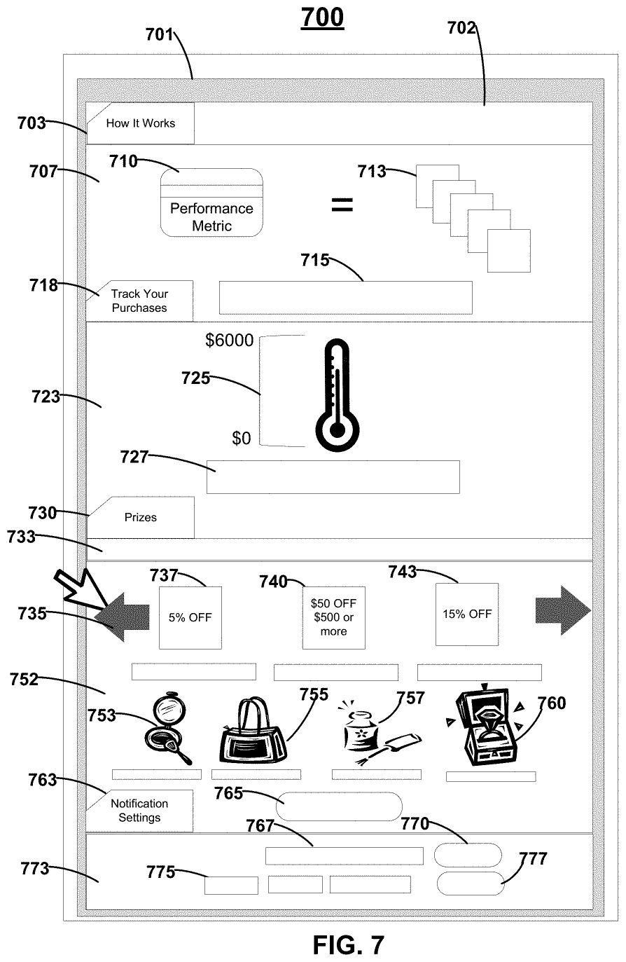

FIG. 7 shows device 700 (e.g., a card, a mobile telephonic device, a laptop computer, a desktop computer and/or an electronic tablet) that may include display 701. Device 700 may include a processor that may render GUI 702 onto display 701. GUI 702 may be an application interface usable to manage a user's experience with an application. For example, GUI 702 may be used to configure application settings, receive information from an application provider, communicate information to an application provider and/or the like.

GUI 702 may include, for example, tabs 703, 718, 730 and 763, application screens 707, 723, 752 and 773, information displays 710, 713, 715, 727, 733, 737, 740, 743, 753, 755, 757 and 760, progress meter 725, entry fields 767 and 775, and selections 765, 770 and 777.

Tab 703 may be used to display application screen 707 and may include a descriptor associated with application screen 707 (e.g., “How It Works”). Upon selecting tab 703, application screen 707 may be displayed to a user. Application screen 707 may be a configuration screen for an application and may include information explaining features provided by the application. For example, application screen 705 may display different configurable, selectable features, along with explanatory information associated with each feature. According to at least one example embodiment, application screen may not be a configuration screen and may be an information screen. A feature may not be configurable and/or selectable (e.g., a set feature) and static feature information may be displayed.

A feature provided by an application may provide a user selected reward once a user meets or exceeds a performance metric. Alternatively and/or additionally, a feature provided by an application may provide a random reward from a collection of rewards once a user meets or exceeds a performance metric. The reward may be provided by the application provider upon a user meeting or exceeding the performance metric. An example of a performance metric may include a user completing one or more purchases meeting or exceeding a monetary value using a payment card.

A feature provided by an application provider may be represented by, for example, information displays 710, 713 and 715. For example, information display 713 may display an image representing a collection of different rewards. Information display 710 may display information associated with a performance metric. The performance metric may be, as one example, a transactional based performance metric represented by an image of a payment card and a monetary value. Information display 715 may include information associated with the performance metric and/or the collection of rewards. For example, information display 715 may notify a user that shopping at a particular store will earn additional rewards, and/or notify a user as to the odds of winning any one of the rewards from the collection of rewards.

As one non-limiting example, application screen 707 may include information describing that a user may earn one random reward from a collection of rewards upon spending at least a monetary value (e.g., $6,000) using a payment method (e.g., a smartphone payment card). If the payment method is used to make purchases from a store (e.g., a particular store associated with the application) the amount spent in order to earn the reward may be reduced (e.g., earn a reward twice as fast).

Upon selecting tab 718, application screen 723 may be displayed to a user. Application screen 723 may include progress meter 725 and information display 727. Progress meter 725 may indicate user progress towards completing a performance metric. Progress meter 725 may be any type of progress meter. For example, a progress meter may be represented as a thermometer with a temperature scale replaced by a monetary scale (e.g., $0-$6,000). By viewing progress meter 725, a user may gauge progress towards a reward. Information display 727 may, for example, display an exact amount spent towards earning the reward.

A type of progress meter 725 is not limited. For example, an application provider may be an actress named ‘Dynama Lemon.’ The application provider may display a representation of a lemon. The representation may be, for example, a black and white outline. As progress is made towards completing the performance metric, the representation of the lemon may be progressively colored-in to demonstrate progress.

Upon selecting tab 730, application screen 752 may be displayed to a user. Application screen 752 may provide details with respect to the representation of the collection of rewards displayed in information display 713, and may include, for example, information displays 737, 740, 743, 753, 755, 757 and 760. Information displays 737, 740 and 743 may each display a representation of, for example, a coupon (e.g., different coupons) and information related to each coupon (e.g., an additional value associated with a coupon when the payment method is used to buy specific products). Information displays 753, 755, 757 and 760 may each display a representation of a tangible item and a description of the tangible item. The coupons and tangible items may be a collection of rewards from which a reward may be randomly awarded to the payment method user upon completion of the performance metric. Selection 765 may be a redemption button that may be used upon completion of the performance metric to receive the random reward. A user may change, for example, notification settings before using selection 765.

As a non-limiting example, a user may be awarded a random reward from among coupons and tangible items. Examples of coupons may include a coupon providing 5% off purchases of a product, $50 off purchases of $500 or more, 15% off purchases from a specific store and/or retailer, and/or the like. Examples of tangible items may include a makeup kit, a purse, nail polish remover, a ring and/or the like. Each item may be, for example, exclusively available to users of the payment method. Persons of ordinary skill in possession of example embodiments will appreciate the broad scope of different types of rewards that may be provided for use of a payment method and additional value that may be provided to a user upon using a payment method in a particular way (e.g., additional value when using the payment method to buy products sponsored by the application provider).

Tab 763 may be associated to notification settings. For example, tab 763 may be selected by a user to display entry fields 767 and 775, and selections 770 and 777. Entry fields 767 and 775 may be used by a user to enter information related to the type of notification (e.g., an email address and/or a text message number). Selections 770 and 777 may be used to submit the information entered into entry fields 767 and 775, respectively.

A user may be notified by the application provider when a reward is earned. The application provider may utilize user submitted notification settings to notify the user. For example, a user may submit an email address using entry field 767 and selection 770. As another example, a user may submit a number (e.g., a telephone number for text messaging) using entry fields 775 and selection 777. A notification email and/or text message may be sent to the email and/or number when a reward is earned. The email and/or text message may include a message indicating that a reward has been earned and that a redemption code usable to retrieve the reward is available. According to other example embodiments, the application provider may attach the redemption code and/or reward to the notification (e.g., embedded in the email). According to still other example embodiments, electronic rewards may be downloaded by clicking, for example, an information display associated with the earned reward (e.g., using an application manager).

Although example embodiments are described with respect to email and/or text messaging, persons of ordinary skill in possession of example embodiments will appreciate that many different notification methods may be used (e.g., telephonic, text messaging, telegram and/or the like). According to at least one example embodiment, no notification may be provided. According to other example embodiments, a user may provide a physical address at which to receive notifications and tangible rewards. According to yet other example embodiments, a user may submit multiple addresses (e.g., one or more email addresses, one or more telephone numbers, and/or one or more physical addresses) and select one of the addresses prior to redemption such that each reward redemption may result in a different notification or fulfillment (e.g., different rewards and/or notifications may be sent to different addresses at the whim of the user).

Although example embodiments described in relation to FIG. 7 may include performance metrics based on a monetary value, various other performance metrics are within the scope of example embodiments (e.g., number of transactions, type of transactions, a user acting as a merchant using a particular merchant service and/or the like).

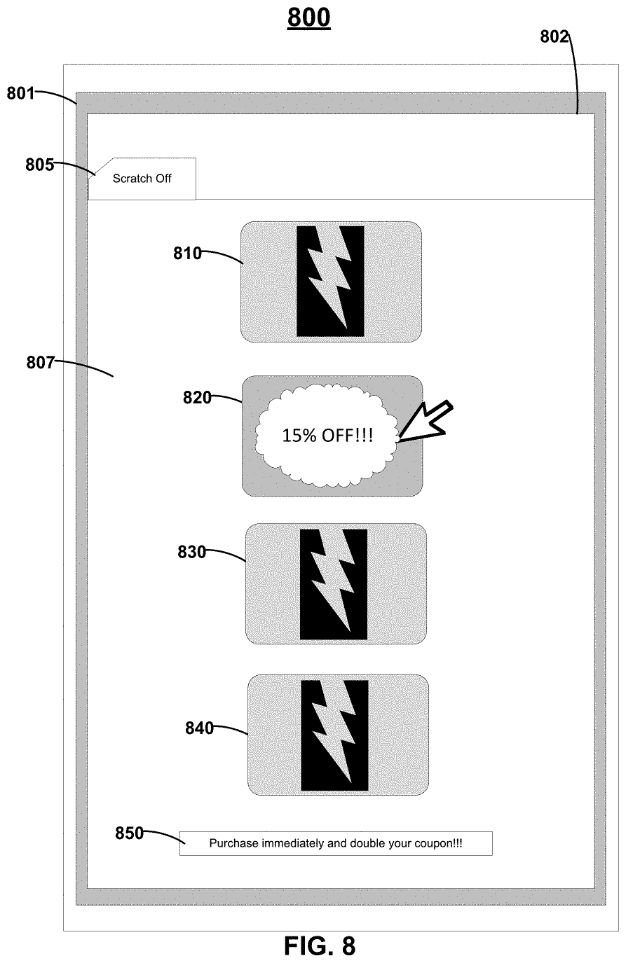

FIG. 8 shows device 800 (e.g., a card, a mobile telephonic device, a laptop computer, a desktop computer or an electronic tablet) that may include display 801. Device 800 may include a processor that may render GUI 802 onto display 801. GUI 802 may be an application interface usable to manage a user's experience with an application. For example, GUI 802 may be used to configure application settings, receive information from an application provider, communicate information to an application provider and/or the like.

GUI 802 may include, for example, tab 805, application screen 807, information displays 810, 820, 830 and 840, and selection 850.

Tab 805 may be used to display application screen 807 and may include a descriptor associated with application screen 807 (e.g., “Scratch Off”). Upon selecting tab 805, application screen 807 may be displayed to a user. Application screen 807 may be an interactive selection screen for an application.

A feature provided by an application may provide a user an opportunity to select one reward from among multiple, hidden rewards. For example, a user may be presented with multiple representations of a logo (e.g., an application provider logo) in information displays 810-840. The user may be provided the opportunity to select one of information displays 810-840 to unveil a reward. For example, a user may select information display 820 to reveal that the user has won a coupon (e.g., 15% off of a purchase).

According to example embodiments, a user may select two or more of information displays 810-840 and receive a reward associated with each selection. For example, multiple performance metrics may be available to the user. Depending on a value (e.g., cost to the user and/or value provided to the application provider) of the performance metric, a different number of selection may be made (e.g., one selection for $50 in spends, two selections for $100 in spends, etc.).

According to example embodiments, an application provider may receive a monetary value from, for example, an ecosystem provider, an issuer, a merchant and/or a payment network in exchange for providing a reward to a user. The monetary value may be, for example, a number of basis points ( 1/100 of a percentage point) related to a transaction. According to some example embodiments, an application provider may not receive a monetary value and/or may provide value. The application provider may receive value, for example, via customer acquisition, retention of customers, marketing (e.g., visibility within an ecosystem) and/or the like. According to some example embodiments, a value provided via a coupon may be greater than a monetary value provided to a coupon provider. A difference in value may be offset by other factors (e.g., high value coupons where 90% of the coupons are expected to expire prior to use).

A performance metric may be based on transactional processing. Transactional processing may include multiple stages. For example, a credit transaction may include authorization, batching, clearing and funding. An application and/or feature provider may provide a reward to a user at one of the various stages of transaction processing (e.g., authorization). In some cases, a transaction may be reversed (e.g., a void or credit) after a user receives a reward based on the transaction. For example, a user may purchase an item, receive an electronic reward and then return the purchased item. According to example embodiments, the application and/or feature provider may be notified by the application manager provider that a transaction has been reversed. A application and/or feature provider may take action based on the notification, for example, provider may reclaim a coupon, invalidate a coupon code, remove user authorization to use an application and/or feature, establish a debit pool that must be reduced by future uses of the payment method before additional rewards may be earned and/or the like.

According to some example embodiments, a reward may be granted to a user at a stage of transaction processing (e.g., authorization) but may not be available for use by the user until a different stage of processing (e.g., settlement). If a transaction is reversed (e.g., via a return, a charge-off and/or a charge-back) after being made available to the user the application and/or feature provider may take steps to remove a value associated with the coupon. Accordingly, if a card is used fraudulently (e.g., a stolen card), rewards may be disassociated with a reward system when the purchases are charged-off as a result of the fraudulent spend.

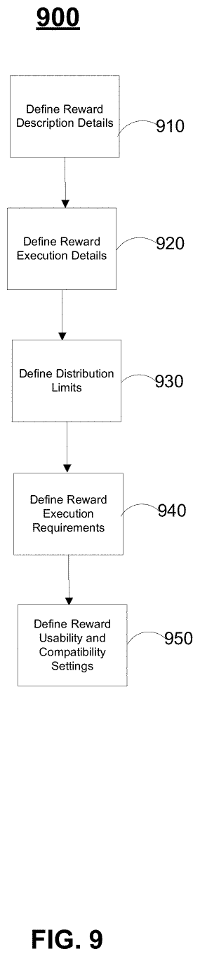

FIG. 9 shows process flow chart 900. According to example embodiments, a rewards provider may utilize an application to configure rewards (e.g., for a rewards or loyalty program). For example, a computing device (e.g., a server) may display an interactive GUI that is usable to define a rewards program via selections and entries.

Referring to FIG. 9, reward description details may be defined (e.g., as in step 910). For example, a rewards provider may select a type of reward, enter a name for the reward, provide a brief description of the reward and upload an image to represent the reward.

The reward type may be, for example, a coupon, an item, a virtual item, cashback, points, miles, entry into a lottery, and/or any other type of reward. Once a reward type is selected, the GUI may display further options tailored to the type of reward.

A rewards provider may define reward execution details (e.g., as in step 920). For example, a coupon provider may determine the type of coupon that will be provided to users by selecting various options. The options may determine, for example, whether or not the coupon will be based on a purchase amount or a purchased product, and the type of discount or rebate to be applied. If the coupon will be based on a purchase amount, the type of discount or rebate may include, for example, a percentage or value based discount. If the coupon will be based on a purchased product, the type of discount or rebate may include, for example, a percentage discount, a value based discount or a replace value.

A rewards provider may set distribution limits for the rewards program (e.g., as in step 930). The distribution limits may define the financial liability that may be incurred by the rewards provider. For example, using an overall limit and/or a per customer limit, a coupon provider may limit the number of coupons that are distributed and/or the maximum value of the coupons (e.g., the value either individually or in aggregate). As one example, a rewards provider may set an overall distribution limit of 1000 coupons and a per customer distribution limit of 5 coupons.

A rewards provider may define reward execution requirements (e.g., as in step 940). Reward execution requirements may, for example, describe the circumstances under which a coupon is redeemable. For example, coupons redemption may be limited to online purchases or store purchases, or permitted for both store purchases and online purchases.

If in-store redemption is permitted, the redemption may be limited to a particular store, a set of particular stores, and/or one or more geographical areas (e.g., by zip code, province/state and/or country). Information that may be entered into a GUI by a rewards provider may include, for example, one or more store ID's, store names, zip codes, province/state information and/or country codes.

Where redemption is permitted online, or online and in-store, reward redemption may be limited to one or more retailers (e.g., Dynamo Sporting Goods), to one or more types of retailers (e.g., sporting goods), by maximum and/or minimum purchase thresholds (e.g., purchase amount thresholds), by duration (e.g., a range of dates), by date (e.g., specific days), by time (e.g., specific hours), and/or by product and/or product group (e.g., to one or more SKU groups).

Accordingly, coupon redemption may be circumscribed by, for example, location, commercial relationships, cooperative interests, and/or logistical considerations. For example, a retailer may increase traffic through stores at historically underperforming times, days or months, reduce percentage reduction liability that may occur for higher value purchases, and restrict coupons to particular products, manufacturers or types of manufacturers. A retailer with knowledge of customer loading patterns within its stores may limit coupon redemption to particular stores at particular times on particular dates to level workload, control local traffic, synergize with staffing levels and/or increase loading at underperforming stores or regions.

A rewards provider may define reward usability and compatibility (e.g., as in step 950). For example, a retailer may define how coupons are used together (coupon usability), define the types of payment methods that are usable during a qualifying purchase (purchase types), and/or define the transferability of the coupons (user restrictions).

For example, defining coupon usability may include selecting whether coupons are usable with all other coupons, with specific coupons or only by themselves. Defining purchase types may include selecting payment methods with which a coupon may be used, for example, all payment methods, specific branded payment methods (e.g., store loyalty credit card), cash, prepaid cash, payment methods supported by specific payment networks (e.g., Visa, MasterCard, Discover and/or American Express) and/or the like. Defining user restrictions may include restricting redemption to a designated user or designated users (e.g., the user to whom the coupon was sent) or permitting redemption by any user (e.g., a transferable coupon).

Although process flow chart 900 includes arrows, the arrows are not limitations of order. Persons of ordinary skill in the art will appreciate that some or all of the described activities may be completed sequentially, in a different order or simultaneously. Although process flow chart 900 may be described above with respect to coupons, persons of ordinary skill in possession of example embodiments will understand the described process to be broadly applicable to various types of rewards. Persons of ordinary skill will understand that whether a process is described with respect to selection or entry, a selection may be implemented with an entry, an entry with a selection, and other possibilities exist (e.g., pulling SKUs from a database or other file).

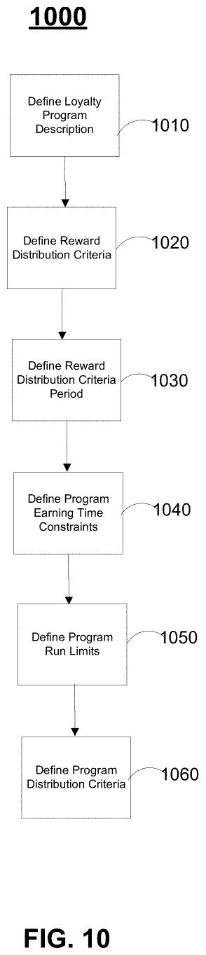

FIG. 10 shows process flow chart 1000. According to example embodiments, a rewards provider may utilize an application to configure a loyalty program. For example, a computing device (e.g., a server) may display an interactive GUI that is usable to define a loyalty program via selections and entries.

Referring to FIG. 10, a reward provider may define a description of a loyalty program (e.g., as in step 1010). For example, a rewards provider may select a program type, enter a name for the loyalty program, provide a brief description of the loyalty program and identify one or more rewards provided by the loyalty program.

The program type may be, for example, a predefined type of loyalty program. Once a reward type is selected, the GUI may display further options tailored to the type of loyalty program.

A rewards provider may define one or more reward distribution criteria (e.g., as in step 1020). For example, a loyalty program may provide a reward based on a monetary value spent (e.g., number of dollars), a number of visits (in-store and/or online), a number of particular items purchased and/or a number of purchases.

A selection to base a loyalty program on monetary value may include entering an amount of the monetary value at which a reward may be provided. A selection to base a loyalty program on a number of visits may include entering the number of visits before a reward may be provided, and may include entering a number of consecutive days on which the visits must occur (e.g., a date range or a number). A selection to base a loyalty program on a number of purchased items may include entering one or more item types, one or more stock keeping units (SKU), and/or entering a number representing the number of items to be purchased before a reward may be provided. A selection to base a loyalty program on a number of purchases may include entering a number representing the number of purchases before a reward may be provided, and may include entering a minimum spend amount per purchase.

A rewards provider may set a rewards distribution criteria period for the loyalty program (e.g., as in step 1030). The distribution criteria period may specify a time period in which the loyalty program is deemed to be active and rewards may be earned. For example, a rewards provider may select an option to provide rewards from program inception or enter a date range. According to some example embodiments, a rewards provider may apply a retroactive time period such that historical data may be used to determine whether a reward was earned (e.g., prior to inception of the program).

A rewards provider may set program earning time constraints with respect to the loyalty program (e.g., as in step 1040). For example, reward earning may be limited such to only specific days, and/or specific days and times. For example, a loyalty program may be implemented to provide loyalty rewards for customers shopping on Black Friday (e.g., Nov. 28, 2014) during non-peak hours.

A rewards provider may define program run limits (e.g., as in step 1050). For example, a rewards provider may select one or more options that may include running a loyalty program until start and end dates have been met (e.g., a date range), a particular amount of rewards have been generated, a particular amount of rewards have been redeemed, a particular amount of value has been generated and/or a particular amount of value has been redeemed.

A rewards provider may define program distribution criteria (e.g., as in step 1060). For example, a rewards provider may elect to distribute rewards only to a particular segment of a customer or consumer base. Rewards may be distributed based on psychographics, for example, any personality trait, value, attitude, interest, and/or lifestyle choice (e.g., “gamers,” “savers,” “sportsters,” and/or “child conscience parents”). Award distribution may be based on, for example, gender, age, income and/or products (e.g., one or more SKUs). For example, coupons for geriatric feminine products may be distributed to female consumers by selecting gender and age as a basis for distribution, and entering product SKUs corresponding to the geriatric feminine products.

Although process flow chart 1000 includes arrows, the arrows are not limitations of order. Persons of ordinary skill in the art will appreciate that some or all of the described activities may be completed sequentially, in a different order or simultaneously. Although process flow chart 1000 may be described above with respect to coupons, persons of ordinary skill in possession of example embodiments will understand the described process to be broadly applicable to various types of rewards. Persons of ordinary skill will understand that whether a process is described with respect to selection or entry, a selection may be implemented with an entry, an entry with a selection, and other possibilities exist (e.g., pulling SKUs from a database or other file).

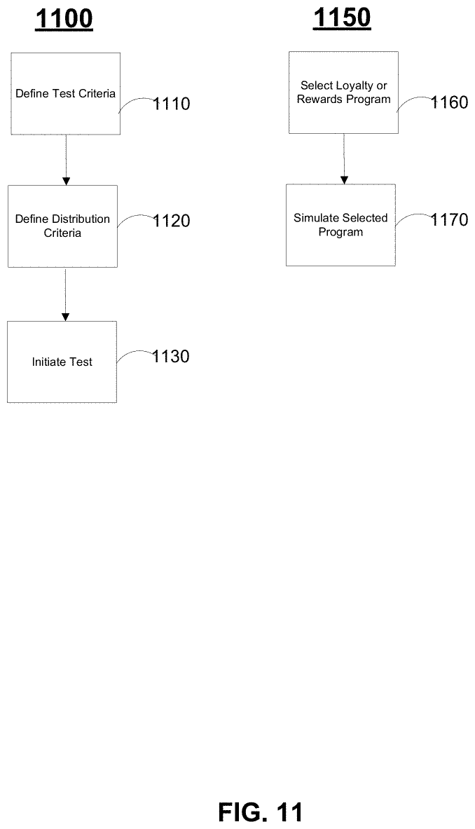

FIG. 11 shows process flow charts 1100 and 1150. According to example embodiments, a rewards provider may utilize an application to test a loyalty and/or rewards program by providing rewards to all, or one or more segments of, identified consumers (e.g., customers) and monitoring the effect of the reward.

The effect of the reward may be determined via test result data in multiple ways and may depend on the reward. For example, if a coupon is offered as a reward, transaction data and/or coupon-use data may be monitored to determine if the coupon resulted in a change in consumer behavior. The data may be collected at one stage of transaction processing (e.g., authorization, settlement, and/or the like), each stage or any combination of stages.

According to some example embodiments, test result data may include segment data from one or more segments receiving a coupon, from one or more segments not receiving a coupon and/or from one or more segments receiving a different coupon (multi-segment testing). Test results may include data from a portion of a segment receiving a coupon and a portion of a segment not receiving a coupon (in-segment testing). Test result data may include data from an entire consumer base (global testing). According to some example embodiments, segment data (e.g., in-segment and/or multi-segment data) collected during the duration of the testing may be compared. According to some example embodiments, before-and-after data may be compared (in-segment, multi-segment and/or global) using collected and historical data.

Referring to process flow chart 1100, a computing device (e.g., a server) may display an interactive GUI that is usable to describe and/or define test and distribution criteria used in program testing (e.g., as in step 1110). For example, a rewards provider may select a loyalty or rewards program for testing, enter a name of the test, enter a brief description, enter a number of rewards to generate, and/or select a percentage or number of consumers (e.g., customers and/or non-customers) to receive the generated rewards. The selected percentage or number may be applied to an entire consumer base (e.g., 100% where no segments are defined), to segments of a consumer base (e.g., x % where multiple segments are defined) and/or to a single segment of a consumer base (e.g., x % where a single segment is defined). Individual segments may be, for example, defined by distribution criteria.

A rewards provider may define one or more segments to be used in program testing be selecting or entering distribution criteria (e.g., as in step 1120). A segment may be based on, for example, psychographics. Psychographics may include any personality trait, value, attitude, interest, and/or lifestyle choice (e.g., “gamers,” “savers,” “sportsters,” and/or “child conscience parents”). A segment may be based on characteristics or goods, for example, gender, age, income and/or products (e.g., one or more SKUs). Consumer psychographics and characteristics may be entered by a user and/or determined from transactional data.

Once all desired parameters for a test are configured, the test may be initiated (e.g., as in step 1130). The coupons may be distributed and data collection begun (e.g., via routing of transaction messages to a remote facility or other entity). At the completion of the test, for example at an expiration date of test coupons, data may be analyzed and results may be provided. Graphs may be displayed to summarize the test results.

According to at least one example embodiment, a test may be repeated one or more times and graphical data may be continuously updated. Repetition may provide temporal or event based effect information (e.g., seasonal habits or the effects of weather). According to at least one example embodiment, tests may be triggered based on events to determine their impact on consumer habits (e.g., geographic testing triggered by a catastrophe).

Referring to process flow chart 1150, a computing device (e.g., a server) may display an interactive GUI that is usable to simulate a loyalty program or rewards program. For example, a rewards program may be built and simulated to ensure that the rewards program functions according to the reward provider's intended design.

A rewards provider may select a loyalty or rewards program (e.g., as in step 1160). For example, the reward program may be selected using the reward description (e.g., “incentive coupon”). The program may be, for example, selected from a list of programs. If the coupon includes a barcode, the type of barcode may be selected. A coupon simulation type may be selected. A coupon simulation type may be, for example, a valid coupon or a test coupon. An address (e.g., email address) of a user and a mail server identification may be entered.

The program may be simulated (e.g., as in step 1170) by, for example, selecting to send one or more test emails (e.g., in a case where coupons are distributed by email), or by entering condition settings and selecting to simulate the program based on the condition settings. A condition may include, for example, maximum liability. The simulation may determine, based on the rewards program, the maximum liability where the maximum number of coupons are distributed and used. Alternatively, percentage of use assumptions and the like may be entered to determine a resulting liability based on the assumptions. In general, conditions may include any parameter used to determine the result of a defined rewards or loyalty program.

Although process flow charts 1100 and 1150 include arrows, the arrows are not limitations of order. Persons of ordinary skill in the art will appreciate that some or all of the described activities may be completed sequentially, in a different order or simultaneously. Although process flow charts 1100 and 1150 may be described above with respect to coupons, persons of ordinary skill in possession of example embodiments will understand the described process to be broadly applicable to various types of rewards. Persons of ordinary skill will understand that whether a process is described with respect to selection or entry, a selection may be implemented with an entry, an entry with a selection, and other possibilities exist (e.g., pulling SKUs from a database or other file).

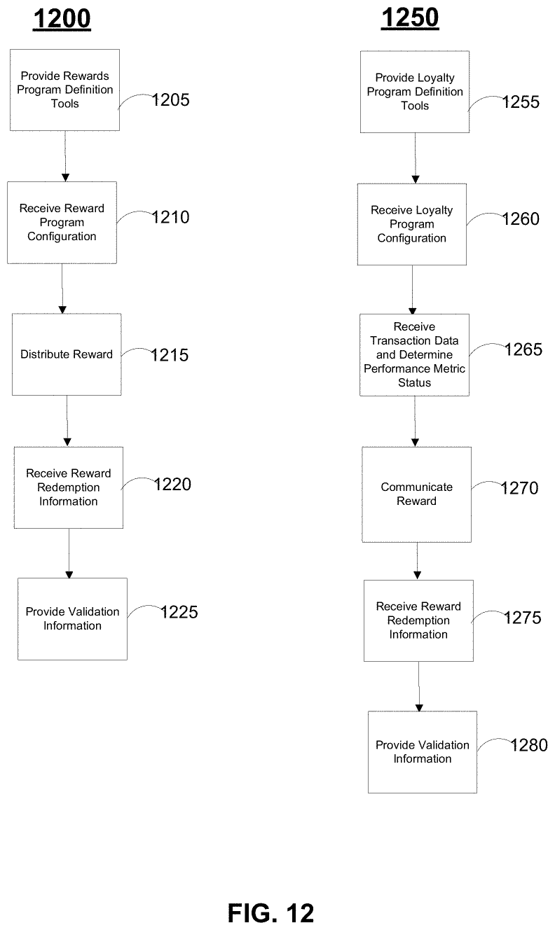

FIG. 12 shows process flow charts 1200 and 1250. Process flow chart 1200 may provide an example of the implementation of a rewards program and process flow chart 1250 may provide an example of the implementation of a loyalty program.

Referring to process flow chart 1200, a computing device (e.g., a server) may display an interactive GUI usable to define a rewards program (e.g., as in step 1205). A remote facility may receive rewards program configurations (e.g., as in step 1210) from, for example, a third party provider (e.g., a retailer). Based on the defined program, the remote facility may distribute rewards according to the program definition. For example, the remote facility may distribute coupons to all customers within a demographic (e.g., globally, by segment, by partial segment and/or the like).

The rewards may be distributed physically (e.g., by mail, courier, in-store and/or the like) and/or non-physically (e.g., via electronic mail, telephonically, SMS messaging, television, social networking and/or the like). For example, a server of a remote facility may receive or pull data from a server of a third party provider, and based on the data distribute coupons to consumers via electronic mail.

The remote facility may receive reward redemption information (e.g., as in step 1220). For example, the third party provider may communicate coupon redemption information to a remote facility (e.g., an ecosystem provider), and/or the remote facility may receive transactional data from one or more network entities in a transactional flow. The transactional data may include, as one example, an authorization message.

The reward redemption information may include, for example, coupon identification information, user information, location information, product information, establishment information (e.g., store ID), purchase price information, and/or any other transactional data. The remote facility may determine if the coupon is valid based on the reward redemption information and a rewards program. The remote facility may, for example, determine if the coupon is recognized as active for a rewards program, and if the coupon redemption meets the requirements of a rewards program.

For example, a rewards program may provide a discount that is only valid at a particular store, on a particular date and for a particular user. The remote facility may receive an authorization message that includes identification of a coupon and determine if the coupon is active for any rewards program. If the coupon is active, the remote facility may compare received transactional information against the requirements for the rewards program.

Based on the validity determination, the remote facility may provide validation information (e.g., as in step 1225) to a third party provider, a merchant terminal, an issuer, and/or other entity. For example, if the coupon is active and the transaction complies with the requirements of a rewards program, the remote facility may communicate information indicating that the discount or rebate may be applied to the transaction. If the coupon does not meet one or more criteria for redemption, the remote facility may indicate that the discount or rebate should not be applied to the transaction. Although example embodiments are described with respect to real-time processing, validation may occur after a purchase, for example, based on settlement.

Referring to process flow chart 1250, a computing device (e.g., a server) may display an interactive GUI usable to define a loyalty program (e.g., as in step 1255). A remote facility may receive loyalty program configurations (e.g., as in step 1260) from, for example, a third party provider (e.g., a coupon provider).

The remote facility may receive transaction data. Based on the transaction data, historical data and a loyalty program definition, the remote facility may determine loyalty program applicability and performance metric status (e.g., as in step 1265).

For example, a server of a remote facility may receive or pull data from a server of a third party provider, or receive transactional messages from an entity within a purchase flow (e.g., as described with respect to FIG. 3). The transactional data may evaluated to determine if a loyalty program applies. For example, a loyalty program may award a coupon to users of a particular loyalty credit card that fall within a particular demographic. The remote facility may evaluate the transactional data to determine if a performance metric has been met. For example, the performance metric may include completing 10 purchases of a particular product using the loyalty credit card. The historical data may indicate that the user has previously purchased the particular product 9 times and the current purchase completes the performance metric.

A reward may be distributed as defined in the loyalty program (e.g., as in step 1270). If the performance metric has been met, a discount may be automatically applied to the transaction by communicating a message (e.g., to a point-of-sale device) and/or a coupon may be communicated to the user.

Where a coupon is communicated to a user, the remote facility may receive reward redemption information (e.g., as in step 1275) upon use of the coupon. For example, the third party provider may communicate coupon redemption information to the remote facility, and/or the remote facility may receive transactional data including reward redemption information from one or more network entities in a transactional flow. The transactional data may include, as one example, an authorization message.

The reward redemption information may include, for example, coupon identification information, user information, location information, product information, establishment information (e.g., store ID), purchase price information, and/or any other transactional data. The remote facility may determine if the coupon is valid based on the reward redemption information and the loyalty program definition. The remote facility may, for example, determine if the coupon is recognized as active for a loyalty program, and if the coupon redemption meets the requirements of the loyalty program.

For example, the loyalty program may provide a discount or rebate that is only valid when used during specific hours in a particular country. The remote facility may receive a message (e.g., a settlement message) that includes identification of a coupon and determine if the coupon is active for any loyalty program. The remote facility may compare the received transactional information against the requirements for the rewards program. For example, the remote facility may determine if the coupon is being used during the specific hours and in the particular country, as required by the loyalty program. If the coupon is active and the requirements of the loyalty program are met, the coupon may be determined valid. Otherwise, the coupon may be determined invalid.

Based on the validity determination, the remote facility may provide validation information (e.g., as in step 1280) to a third party provider, a merchant terminal, an issuer, and/or other entity. For example, if the coupon is valid, the remote facility may communicate information indicating that the discount or rebate may be applied to the transaction. If the coupon is not valid, the remote facility may indicate that the discount or rebate should not be applied to the transaction. Although example embodiments are described with respect to settlement processing, validation may occur, for example, at authorization (or any other stage of processing).

Although process flow charts 1200 and 1250 include arrows, the arrows are not limitations of order. Persons of ordinary skill in the art will appreciate that some or all of the described activities may be completed sequentially, in a different order or simultaneously. Although process flow charts 1200 and 1250 may be described above with respect to coupons, persons of ordinary skill in possession of example embodiments will understand the described processes to be broadly applicable to various types of rewards. Persons of ordinary skill will understand that if a process is described with respect to selection or entry, a selection may be implemented with an entry, an entry with a selection, and other possibilities exist (e.g., pulling SKUs from a database or other file). According to example embodiments, cards, ecosystems, third party applications, testing, simulation and transaction flows may be included in the implementation of a reward or loyalty program.

Example embodiments described with respect to process flow charts 1200 and 1250 are not limiting of example embodiments, but serve as examples. Various transactional flows and systems may be implemented in various ways (e.g., as described with respect to FIG. 3). Although specific entities may be used to describe example embodiments in relation to FIG. 12, various entities may perform one or more functions of other entities, and the particular entities used to describe FIG. 12 are not limiting.

A value document (tangible or intangible) may be used to generate demographic information to understand consumer behavior by providing, for example, incentives to purchase, reductions in the price of particular items, free samples, and/or the like. For example, a value document may provide free shipping, buy-one get-one, trade-in for redemption, a coupon for a first-time customer, free trial offer, launch offer, special event offer and/or free giveaway. A value document may be, for example, a coupon providing $5.00 off a $10.00 purchase, and the coupon may be represented by a two or three dimensional barcode. A price conscious consumer may, for example, present a coupon to check out at a merchant, and the merchant may retain the coupon and offer the consumer a loyalty card during the check-out process. Consumer acceptance of the loyalty card may be low.

According to some example embodiments, a value system may issue an value identifier to influence consumer behavior for loyalty or advanced coupon features. For example, a value system may provide a multistage value account identifier which is individualized based on use of the multistage value account identifier. The multistage value account identifier may be, for example, a single code (e.g., represented by a barcode). The multistage value identifier may be associated to a multistage value account. According to example embodiments, the multistage value account may or may not be associated with a particular user.

A multistage value account may be associated with a defined or undefined set of stages. A stage may require, for example, a particular action (e.g., a purchase or a game move). For example, at a first visit to a retailer, a user may present a multistage value account identifier to receive $5.00 off a $10.00 purchase, and at a second visit receive $10.00 off a $20.00 purchase, and at a third visit receive $15.00 off a $20.00 purchase and at a fourth visit receive a free sandwich along with a message announcing that the user of the multistage value account identifier has achieved status and will be provided a card (e.g., gold status card) upon providing user information (e.g., a telephone number, email address, physical address and/or other information associated with the consumer). The card may, for example, represent a conventional loyalty program, specific privileges and/or expand the benefits provided by the multistage value system (e.g., with increasingly individualized customization based on information obtained from redemption associated with the stages of the multistage value account and/or based on user information).

User information may be requested via, for example, a retailer POS system, a method specified by the POS system, a receipt and/or an online purchase confirmation. According to some example embodiments, a user may receive an advertisement including a multistage value account identifier or method of obtaining a multistage account identifier, along with information indicating that upon achieving a particular stage the user is eligible for a status card upon submitting user information (e.g., to a website URL). According to at least one example embodiment, use of a multistage value account identifier may be conditioned on consent by the user for access to user information, for example, user information stored by a merchant, acquirer, issuer, processor, payment network, third party service provider, remote facility, device provider, mobile service provider and/or any other entity.

A multistage value system may be an implementation of an abbreviated (mini) loyalty program or an introductory loyalty program and a user may be seamlessly converted from the multistage value account to a value program. For example, a user may be converted to a loyalty card representing an extension of the multistage value system, or a different and/or traditional loyalty program. Consumer acceptance of the loyalty card may be increased and/or high as compared to conventional program offerings at checkout.

According to some example embodiments, one or more stages of a multistage value account may expire. According to other example embodiments, no stage of a multistage value account expires. According to still other example embodiments, one or more stages of a multistage value account may include a change date after which a different value is offered to the consumer.

According to some example embodiments, a consumer may be offered a choice of value from a pool at a first stage. According to other example embodiments, a choice may be presented to a user at one or more stages or every stage of a multistage account. According to still other example embodiments, no choice is offered to the user.

Machine learning may be applied to determine the value or pool of values offered at one or more stages of a multistage value account based on, for example, previous value selections by a user, use of the multistage value account identifier (e.g., redemption data), information submitted by a user, demographic data and/or any other information relevant to individualizing value to a user of a multistage value account.

Artificial intelligence may, for example, provide a multistage value system subscriber segmentation including groupings or patterns within a customer base of the subscriber. According to some example embodiments, the multistage value system subscriber may be offered choices of values to be offered to a user at one or more stages based on segmentation. A multistage value system subscriber may be, for example, a game company, issuer, processor, acquirer, payment network, merchant, property owner (e.g., mall owner or strip mall owner) and/or an affiliate of a collection of merchant brands subscribing to, or operating, a multistage value system. A multistage value system may according to at least some example embodiments be provided by a third party from a remote server.

A value offered to a user during one or more stages of a multistage value account may be the result of, for example, an online game or games (e.g., game scores). A value offered during one or more stages may be random, for example, the result of a virtual scratch-off.

The system may be a merchant, cross-merchant, product and/or issuer centric system. For example, a merchant multistage value system may offer a user a value at each of multiple stages, the value usable or in exchange for, among other things, making purchases from the merchant, making purchases from different stores of the merchant and/or purchasing different preferred products from the merchant.

As another example, a cross-merchant multistage value system, which may be provided by, for example, an issuer, and may offer a user a sequence of values corresponding to a sequence of purchases from different merchants. For example, a user may be provided values usable or in exchange for making a purchase at a first merchant at a first stage, at a second merchant at a second stage, a third merchant at a third stage or any combinations of merchants with or without repeats. Stages may be related to, for example, non-competitive merchants, merchants familiar to one another, merchants selected according to machine learning and/or combinations thereof. According to at least one example embodiment, a multistage value account may include stages related to companies adverse to each other with the stage placement based on preferences of a multistage value system subscriber.

A user may be offered value for making a sequence of purchases of a particular product or a product from a family of products (e.g., for purchases of different flavors of a particular brand of ice cream). A user may be offered a single value for making a purchase at a sequence of vendors, either additional to values provided at one or more individual stages of the sequence or otherwise.

According to at least one example embodiment, a multistage value system may be used to induce user behavior. For example, a user may be offered value for travelling to specific geographic areas (e.g., malls, shopping districts, community revitalization projects) or different geographic locations (e.g., game vendor, amusement park locations, recreational facilities).

The multistage value system may be, for example, provided via a server of a merchant, acquirer, issuer, processor, payment network, third party service provider, remote facility, device provider, and/or any other entity. A multistage value account identifier may be obtained in any manner value offers may be made. For example, a multistage value account identifier may be printed as a barcode on a receipt. Alternatively, for example, a user may obtain a generic identifier, submit the generic identifier and receive a multistage value account identifier. For example, a user may take a picture of a generic identifier in a newspaper or a screenshot of a web based advertisement, text or email the picture to a number provided in the newspaper or advertisement and receive a multistage account identifier in return from that number. Persons having ordinary skill in the art in possession of this specification will understand that many different ways of providing an identifier are achievable and contemplated

According to some example embodiments, a multistage value account may offer value based on a number of stages completed within a period of time (e.g., one month) and/or may change value based on the length of time between stage completion and/or may change the value based on the average length of time between completion of multiple stages and/or provide value based on a period of time in which all stages are completed.

According to example embodiments, a multistage value account identifier may be the same for all stages, different for groupings of stages or different for each stage.

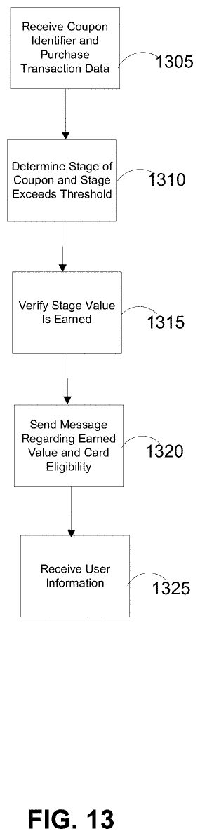

FIG. 13 is an illustration of a process flow chart constructed in accordance with the principles of the present invention. Referring to FIG. 13, a server may receive a multistage value account identifier (e.g., a coupon identifier of a multistage coupon) and at least a portion of purchase transaction information (Step 1305). The server may use the multistage value account identifier to access multistage account data associated with the identifier, obtain a current stage associated with the multistage value account and a stage threshold, and determine that the current stage is equal to or greater than the stage threshold (Step 1310). The server may verify that the purchase qualifies a user of the multistage value account identifier to receive a value associated with the current stage based on the purchase transaction information (Step 1315). The server may communicate a message indicating the earned value and eligibility for a loyalty card associated with the multistage value account based on the threshold (Step 1320). User information may be received by the server in response to the message (Step 1325).

According to example embodiments, a multistage account may be associated a number of stages that may be completed in any order. For example, one stage may provide a free coffee upon purchasing a dinner from Dew-Rain-Dew Restaurant, or in real-time, for example, upon ordering, such that the coffee is enjoyed as part of the experience. A second stage of the multistage value may provide, for example, a free biscuit with breakfast, and a third stage may provide, for example, a free side with an entrée at lunch. Upon completing all three stages, the user may receive an all-stage completion reward, for example, a $10 gift card.

According to some example embodiments, an employee of Dew-Rain-Dew Restaurant (e.g., a waitperson) may accept a multistage value account identifier at any portion of the dinner meal. For example, the employee may scan a QR Code displayed on a phone of the customer. The QR code may include the multistage value account identifier and may be uploaded to a remote server along with a merchant code indicating a purchase of a qualifying dinner. As another example, the customer may be provided with an SMS number (e.g., a dynamic number that changes based on time) linked to such a remote server and associated with Dew-Rain-Dew restaurant, such that the multistage value account identifier may be texted to the remote server and the purchase of the dinner confirmed simultaneously. As yet another example, the customer may not possess, and may be provided with, a multistage value account identifier for a new, unused account, for immediate or future use. According to at least one example embodiment, a merchant may permit back credit for previously purchased products (e.g., previous meals purchased from Dew-Rain-Dew Restaurant) and may provide a URL linked to a web GUI for managing a multistage value account.

The remote server may keep track of the stages and their completion regardless of the temporal order of completion. For example, the remote server may receive the multistage value account identifier and a merchant flag indicative of a stage, and update the multistage value account to reflect stage completion. The remote server may communicate with merchant systems to affect application of the value, and if all-stage completion is achieved, provide value and/or notice to the multistage value account user. For example, the remote server may communicate with Dew-Rain-Dew Restaurant's register or billing server such that the free coffee is properly accounted for in the bill and if all-stage completion is achieved, provide notice to the multistage value account user (directly or through Dew-rain-Dew's employee).

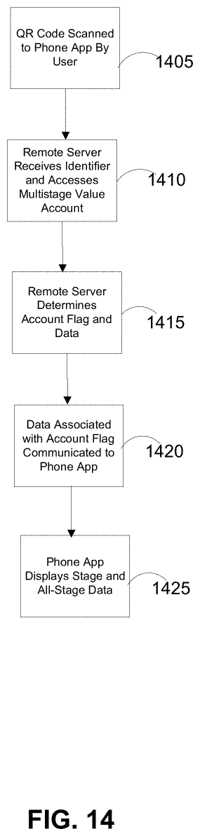

FIG. 14 is an illustration of a process flow chart constructed in accordance with the principles of the present invention. Referring to FIG. 14, a user may scan a QR Code using a phone application (Step 1405). A server may receive a multistage value account identifier from the phone application and access the multistage account data associated with the identifier (Step 1410). The server may determine that the account is flagged for stage completion in any order and obtain stage completion data associated with the multistage value account (Step 1415). The server may communicate the flag and data to the phone application (1420). The phone application may display a list of stages showing which stages are complete, which stages are yet to be completed or a combination thereof, and may display stage requirements and values for uncompleted stages, and display a value associated with completion of all stages (1425). Accordingly, the user of the multistage value account may at any time check which stages are yet to be completed and verify the all stage completion reward, adding to the festive nature of the multistage value account.

According to at least some example embodiments, software and/or hardware may be included in, for example, a point-of-sale (POS) terminal that identifies a barcode. For example, a POS terminal may identify a QR code as being a QR code for a specific action, such as to authorize payment for a transaction.

The barcode, such as a QR code, may identify routing information for that barcode. The barcode as well as additional data, such as basket level purchase data and other data associated with a transaction (e.g., tax amount) may be communicated to the routing identity in the barcode. According to at least one example embodiment, the barcode may identify routing information and include the additional data.

The barcode and/or associated data may be routed to the routing identity for further processing. Persons skilled in the art will appreciate that multiple barcodes may have been utilized with a purchase. For example, one or more coupon barcodes may have been used for discounts, a loyalty barcode may have been utilized for loyalty account identification, an installment barcode may identify a user's desire to pay for a purchase in installments, a points barcode may indicate that a purchase is to be paid with points (e.g., loyalty points) and a payment barcode may have been provided to complete payment for the transaction.

According to at least one example embodiment, a barcode, such as a QR code, may be encoded in a manner to convey a greater amount of data than a conventional QR code, using for example a high capacity QR format (e.g., 177×177), multi-level data, data compression, or defined combination function flags. Multiple QR codes may be condensed into a single QR code. For example, a user may provide a POS terminal with a QR code that includes payment routing, loyalty, discount, installment, and/or points information, and/or other information. A QR code may, for example, indicate combinations of QR codes to be communicated to a routing identity (e.g., a payment QR code with an installment QR code for a third party installment plan provider to define an installment plan).

According to some example embodiments, each barcode may initiate a different process and information may be routed to those different processes (either in parallel or in serial). The identification of the type of process (e.g., coupon, loyalty, payment, installment, points) may be determined at the point-of-sale terminal or at a routing identity. All such barcodes may have the same routing identity or a different routing identity.

The system at the routing identity may receive, for example, all information, including all barcodes, and may determine the type of each barcode and initiate processes based off that determination.

For Payment, the type of the barcode may be identified as a payment type. The barcode may then include additional identifying information, such as the payment network for the payment account, the bank for the payment account, the user's account from that bank account, and additional discretionary data. In that discretionary data may be a dynamic security code that changes with every use. Accordingly, different barcodes may be provided by a device (e.g., a phone, watch, or battery powered card with a display) to make a payment at a store (e.g., via a point-of-sale system) and each of those barcodes may be associated to the same payment account from the same payment network and issuing bank with the difference being, at least in part, dynamic security data. For discount . . . For loyalty . . . .

Persons skilled in the art will appreciate that magnetic stripe information could be, for example, represented as a barcode. A dynamic magnetic stripe security code, may be provided as part of the dynamic magnetic stripe data. Such data may be communicated to a point-of-sale terminal, identified and routed to that identified process, and the identified process may replace the barcode with magnetic stripe data, or generate magnetic stripe data, and may communicate this information to a payment network and perform an authorization process for that magnetic stripe data with a payment network. Persons skilled in the art will appreciate that a token may be utilized, such as a token issued by a token issuing entity, as the data for payment authorization.

Upon approval of the payment data, a message may be sent back to the point-of-sale terminal that causes the transaction to be completed. This can be done in many ways. For example, an amount of value may be stored in escrow and the point-of-sale terminal may be provided with indication that stored value is being utilized for the purchase amount and, after the transaction completes, the merchant's account may be deposited with the amount of the purchase. As such, the merchant may get access to funds quickly after a purchase transaction occurs.

As per another example, merchants may enter into contracts to accept the payment network's issuers barcodes for various types of payment (e.g., debit, credit, pre-paid) and transactions may be authorized and merchants paid within these terms.

Bank issuers may include their own wallets that run their own cards as dynamic barcodes, such as dynamic QR codes. Phone manufactures may find such features difficult to block as such features do not include the use of secure hardware on the devices.

The barcodes may be generated locally using local algorithms (e.g., stored in white box crypto approaches on the phone applications) or may be retried from a third party (e.g., retrieved and stored from a secure cloud). Such barcodes may be retrieved in batches (e.g., of 5 or more, 10 or more, 100 or more, etc). Such barcodes may be deleted after use so that the information is not retained on the device in any form.

A multi-issuer and multi-network wallet may be provided that permits a consumer to load in dynamic barcodes from various issuers. A user may be able to enter in his/her payment information either manually or via a phone (with an OCR component of an application reading information from the picture of the card). A token service may then be called to obtain an eligible payment token for the card. This token may be converted into a static or dynamic QR code.

Persons skilled in the art will appreciate that software may be included in point-of-sale terminals to recognize the barcode (e.g., as a Dynamic Payment Barcode) and the information to complete a transaction (e.g., payment total, basket level data of items purchased, tax information, etc) may be communicated to a dynamic payment process. The dynamic payment process may check to determine if other barcodes are utilized (e.g., a coupon barcode, loyalty barcode, etc.) and all barcode may be processed in order to properly complete a transaction. The barcode may identify the network and the appropriate information for that network may be communicated to obtain authorization of the payment information.

A decline may be received from the network and cause a decline communication to be sent to the point-of sale.

An approval may be received from the network and cause an approval communication to be sent to the point of sale.

Additional information may be sent to the network, such as additional information to assist with other processes such as fraud detection and marketing insight evaluation.

Persons skilled in the art may appreciate that the identification steps may be included in the point-of-sale. Persons skilled in the art will appreciate that a point-of-sale may simply be the phone itself. A consumer may send a barcode from his/her phone to another phone and that phone itself may authorize the barcode and act as a barcode point-of-sale and/or identification and payment authorization process.

Super Smart Secure Payment Applets with Pre-Stored Messages and Logic and Ability to Change Subsequent Function Thereon

A payment card or other device such as a payment phone or watch, can interact with a point-of-sale terminal to complete a transaction. Multiple stages of communications from the payment device to the payment terminal and from the payment terminal to the payment device can be provided so that each device or process can identify itself to each other, securely confirm the other identity is authorized to conduct a transaction, and provided information for the authorization of a payment transaction. The point-of-sale terminal may route such communications to/from a merchant processor which may route parts of the communication to/from a payment network process, which may route part of the communications to/from an issuing processor that issued the payment device to the end consumer.

The transaction may be communication between the payment device and point-of-sale terminal, for example, a contact chip connection, a contact or wireless magnetic stripe connection, a contactless connection, or through a visible connection such as a single-stage or multiple-stage barcode or QR code. A multiple-stage barcode may be a barcode that changes the information displayed throughout a payment transaction process so that multiple different types of information are displayed at different times over the same display area.

During a transaction, a payment device may request information. This information may include, the amount authorized, additional monetary amounts, the country code of the terminal, the terminal verification results, the transaction currency code, the transaction data, the transaction type, the data authentication code, the iCC dynamic number, the CVM results, the transaction time, merchant custom data, transaction date, tvr, unpredictable number, whether the transaction was authorized or declined, or any type of data retrievable by the payment card.

A payment card may be battery-powered or non-battery powered and may include buttons to permit a consumer to select different payment accounts (e.g., debit, credit, pre-paid), payment options (e.g., pay with points, pay with equal monthly payments such as 3, 6, 9, 12, 15, 18, 21, 24, 27, 30, 36, 39, 42, 45, or 48 monthly payments, or other payment features (e.g., a password-entry system where a correct password is needed to use the card to complete a purchase).

The payment devices may include multiple processors—such as a general processor for managing the general operation of the device and a payments processor or secure memory element for managing all or part of the payment data and payment process of the device.

Data not associated with the direct authorization of a payment may be copied from information requested from the payment device and stored and utilized for non-payment or payment features.

For example, a card may have a display such as a pixelated display operable of displaying a cardholders payment network logo, cardholder name, payment account number, payment expiration date, payment security code for online transactions (e.g., CVV2, CVC2), card name, and other pieces of information.

Messages associated with a particular time and/or date may be pre-stored. For example, messages associated with an anniversary date of the issuance of the card, consumer birthday information, country holidays, religious events, or any notification or message associated with a particular time or date. For example, a message wishing the consumer a happy birthday and providing the consumer with a QR code coupon for a certain amount in value may be displayed based on a date received during a payment transaction (and, for example, a clock in the payment device that updates the stored date as time passes). Persons skilled in the art will appreciate that a birthday event may trigger a feature such as a game feature where a consumer gets to pick a gift box from a number of gift boxes where each or one ore of the gift boxes has a different amount or type of value stored in it. Accordingly, a marketing campaign may be provided where on your birthday you have the chance to win a statement credit for your payment card bill in different amounts based on, for example, an instant no-purchase necessary sweepstakes where on the cardholders birthday the cardholder is provided instant statement credit value based on different odds of receiving different amounts of value. Pre-stored messages based on time could be provided so that a different message is released at a particular time (e.g., 9 am EST) every day. Date-based messages could include for example, new years, Christmas, Ramadan, each day of hannakah, memorial day, independence day, election day, etc.

Messages may be displayed on the payment device for example based on the first authorized transaction after a certain date/time. For example, a message may be pre-stored and displayed on the first authorized transaction after the first year of being issued the payment device or payment account on the payment device.

Payment devices, such as payment cards, may include, for example, one or more displays, light emitting diodes, programmable magnetic stripes that can change the magnetic stripe data on the magnetic stripe, programmable EMV chips, programmable contactless chips, cellular chips and antennas for downloading data from a remote source, manual interfaces, sound interfaces, etc . . . .

Security features may be provided based on the received data. For example, a dynamic security code may be changed based on time and/or date information received from the payment device during an authorization transaction on a two-way authorization process (e.g., via an EMV or contactless transaction). The dynamic security code may provide a dynamic in-stripe security code (e.g., CVC1/CV1) and on-line security code (e.g., CVC2/CVV2). They may be the same or different security codes based on time and/or date or other information received and multiple types of information received (e.g., a different code may be provided based on time and country information received during a payment transaction).

Pre-stored messages may be provided based on any information received such as, for example, country code. A welcome message may be provided after a consumer makes a payment transaction in a new country that welcomes the user to the country and provides the consumer with payment information (e.g., exchange rates) based on that country. After each authorized transaction, for example, a card may display information on the transaction (e.g., amount of the transaction) in both the local and foreign currency by using information received and/or logic on the card.

Transaction applets may be provided that changes the account or payment option information based on what was received during the transaction. For example, if a US card account is utilized in Spain then the card may change the account to a Spanish account for future transactions (unless otherwise directed by the cardholder). In doing so, the payment device can receive information and change the way the payment devices operated based on the received information.

Any information could enable a new account (e.g., debit credit) or payment option (e.g., EMI, pay with points) for the current or a future transaction. A card can terminate a transaction based on information received and start a subsequent transaction (e.g., by having the cardholder remove and replace the card in a chip contact reader or reinstitute a new contactless transaction, etc. Persons skilled in the art will appreciate that payment terminals can be constructed to reinstitute transactions automatically if a transaction fails.

Example types of information receivable to cause modification of an applet, or by an applet, may include, for example:

Amount, Authorized (Numeric)

Amount, Other (Numeric)

Terminal Country Code

Terminal Verification Results

Transaction Currency Code

Transaction Data

Transaction Type

Data Authenticiation Code

ICC Dynamic Number

CVM Results

Transaction Time

Merchant Custom Data

Transaction Currency Code

Transaction Date

Transaction Type

TVR

Unpredictable Number

According to example embodiments, methods of personalization and personalization updates to credit cards in the field are disclosed.

Perso Data Encryption. According to some example embodiments, encrypted personalization data may be sent over a transmission link (e.g., cell network, Bluetooth, NFC, etc.). A perso data block may have a unique session identifier preprogrammed into a secure element (SE) which may be used as part of an decryption process.

Data may be encrypted at multiple levels. For example, a two level embodiment may include transmission link encryption. An entire block of perso data may be encrypted (e.g., 3DES, AES, etc.) during transmission. This block may be decrypted by, for example, a general purpose processor (GP). The GP may use a unique Session Identifier to request the transmission decryption key from the Secure Element.

Such a two level embodiment may further include encryption of sensitive perso data (personal data of a cardholder)—sensitive perso data such as UDKs may be encrypted such that they will never be in the clear. This information may be sent encrypted to the SE (such as a secure element chip) and may be decrypted inside the Secure Element. This decryption process may be performed by an applet installed on the SE.

Cards may be preloaded with sets of keys in the SE that are associated with: Transmission Link Key—This key may be utilized by the GP to decrypt the entire perso data block that was received. The GP may provide the unique session identifier provided with the perso data Block to the SE such that the appropriate key can be provided. Multiple unique transmission keys (each associated with a unique Session Identifier) may be preloaded such that multiple perso upgrades can be performed over the life of the card. This process may be protected from attacks by, for example, only allowing three attempts to request the transmission link key and if the proper unique session identifier is not provided within three attempts, the process may be blocked going forward. Sensitive Perso Data Key—This key may be utilized by the SE to decrypt sensitive perso data. The unique session identifier may be provided to the SE to be able identify the proper preloaded keys to decrypt the sensitive perso data. Multiple unique sensitive perso data keys (each associated with a unique Session Identifier) may be preloaded such that multiple perso upgrades may be performed over the life of a card. This process may be protected from attacks by only allowing three attempts to provide a unique session identifier and if the proper unique session identifier is not provided within three attempts, the process will be blocked going forward.

Preloaded Perso Data. According to some example embodiments, preloading either multiple entire sets of perso data or multiple partial sets of perso data (which may be unique to this card) which may be triggered to be used by sending a signal to the card over a transmission link (e.g., cell network, Bluetooth, NFC, etc.) to change account information.

Complete sets of Perso Data—Multiple sets of Perso Data which may include changes based on an update to PAN sequence number only or entirely different PANs can be preloaded on the SE. Each of the accounts may be associated with a Unique Account Identifier programmed into the SE. When a change in account is deemed necessary a signal may be sent to the card including the Unique Account Identifier associated with the next set of account data. This unique account identifier may be sent to the SE and if it matches the next account data the card may begin using that account information. This process may be protected from attacks by only allowing three attempts to provide a unique account identifier and if the proper unique account identifier is not provided within three attempts, the process may be blocked going forward.

Partial Sets of Perso Data—In order to minimize the amount of data preloaded, only the unique data associated with an account upgrade (PAN, UDKs, certificates, etc.) may be preloaded. Multiple partial sets of Perso Data which may, for example, include changes based on an update to PAN sequence number only or entirely different PANs may be preloaded on the SE. Each of the Partial Sets of Perso Data may be associated with a unique account identifier programmed into the SE. When a change in account is deemed necessary a signal may be sent to the card including the unique account identifier associated with the next set of account data. This unique account identifier may be sent to the SE and if it matches the next account data the card may begin using that Account information. This process may be protected from attacks by only allowing three attempts to provide a unique account identifier and if the proper unique account identifier is not provided within three attempts, the process may be blocked going forward.

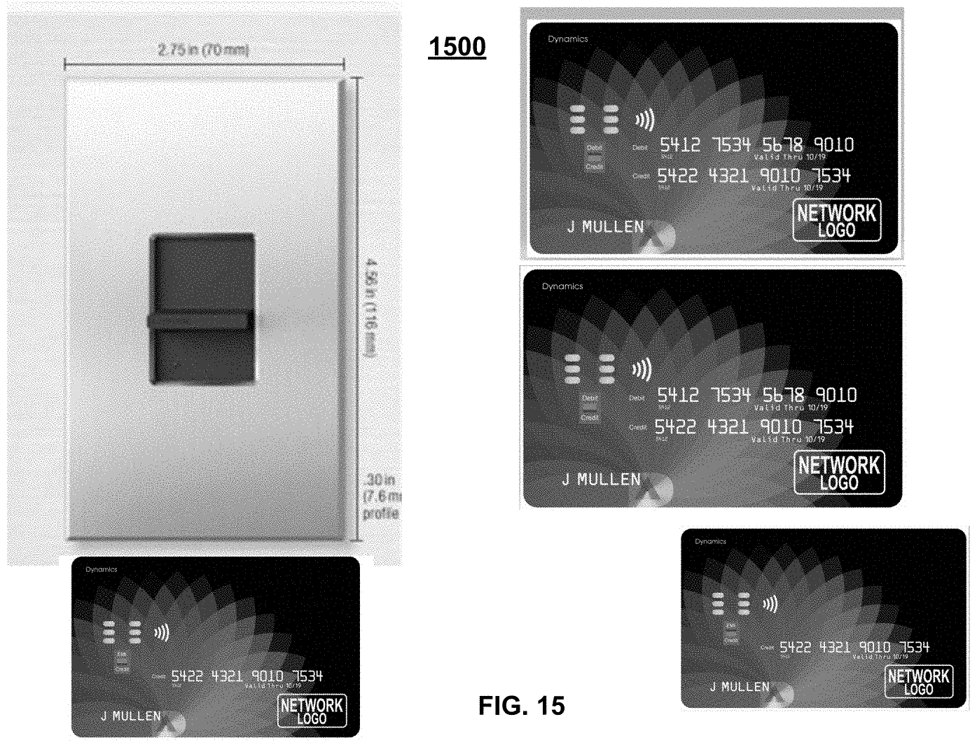

Referring to FIG. 15, a slider may be used to select different features instead of, for example, a button.

Persons skilled in the art will appreciate that the present invention is not limited to only the embodiments described, and that features described in one embodiment may be used in a different embodiment. The present invention more generally involves dynamic information and devices. Persons skilled in the art will also appreciate that the apparatus of the present invention may be implemented in other ways than those described herein. All such modifications are within the scope of the present invention, which is limited only by the claims that follow.

What is claimed is:

1. A method, comprising:
communicating, by a payment card, transaction information indicative of a first account during a first transaction, the first account associated with a first country;
receiving, by a payment card, location information indicative of a second country during the first transaction; and
communicating, by the payment card, transaction information indicative of an account associated with the second country during a second transaction based on the location information.

2. The method of claim 1, wherein the location information is a terminal country code.

3. A method, comprising:
communicating, by a payment card, transaction information indicative of a first currency during a first transaction, the first currency associated with a first country/location;
receiving, by a payment card, currency information indicative of a second country/location during the first transaction; and
communicating, by the payment card, transaction information indicative of a currency associated with the second country/location during a second transaction based on the currency information.

4. The method of claim 3, wherein the currency information is the transaction currency code.

5. A method, comprising:
communicating, by a payment card, transaction information indicative of a first network (i.e Visa, MasterCard, JCB, etc.) during a first transaction, the first network associated with a first country;
receiving, by a payment card, location information indicative of a second country during the first transaction; and
communicating, by the payment card, transaction information indicative of network associated with the second country during a second transaction based on the location information.

6. The method of claim 5, wherein the location information is a terminal country code.

7. A method, comprising:
communicating, by a payment card, transaction information indicative of a first account during a first transaction, the first account associated with a first date/time range;
receiving, by a payment card, date/time information indicative of a second date/time range during the first transaction; and
communicating, by the payment card, transaction information indicative of an account associated with the second date/time range during a second transaction based on the date/time information.

8. The method of claim 7, wherein the date/time information is a transaction date and/or transaction time.
